(19) United States
(12) Patent Application Publication
(10) Pub. No.: US 2022/0169060 A1
(43) Pub. Date: Jun. 2, 2022

(54) THERMOSENSITIVE RECORDING MEDIUM AND IMAGE-FORMING METHOD

(71) Applicant: CANON KABUSHIKI KAISHA, Tokyo (JP)

(72) Inventors: Ayano Mashida, Kanagawa (JP); Yasuhiro Aichi, Tokyo (JP); Masanobu Ootsuka, Tokyo (JP); Junji Ito, Kanagawa (JP)

(21) Appl. No.: 17/531,562

(22) Filed: Nov. 19, 2021

(30) Foreign Application Priority Data
Nov. 27, 2020 (JP) 2020-197404
Oct. 19, 2021 (JP) 2021-171010

(51) Int. Cl. B41M 5/46; B41J 2/32

(52) U.S. Cl. CPC B41M 5/46; B41J 2/32

(57) ABSTRACT

A thermosensitive recording medium having a thermosensitive coloring layer containing an electron-donating dye precursor, a radical photopolymerization initiator, and an electron-accepting compound with a radical polymerizable group, wherein the electron-accepting compound with a radical polymerizable group includes a compound A represented by the formula (1):

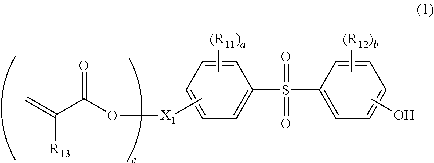

### BACKGROUND

### Field of the Disclosure

The present disclosure relates to a thermosensitive recording medium and an image-forming method using the thermosensitive recording medium.

### Description of the Related Art

Thermosensitive recording media utilizing a color development mechanism in which a leuco colorant is allowed to react with a developer have been widely used. Thermosensitive recording media do not require consumables, such as inks and toners, and are relatively inexpensive. Thermosensitive recording media are therefore widely used as recording media for facsimile, receipts, and other applications. Typical thermosensitive recording media are produced by printing or coating and drying a thermosensitive coloring composition liquid containing water on a supporting member to form a thermosensitive coloring layer.

Furthermore, a method for forming a thermosensitive coloring layer by ultraviolet radiation of an ultraviolet-curable thermosensitive coloring composition is also being studied. For example, Japanese Patent Laid-Open No. 3-72358 discloses (1) a photocurable composition containing an electron-accepting polymerizable vinyl monomer and a photopolymerizable compound and (2) a photosensitive/thermosensitive recording material having a photosensitive/thermosensitive layer containing microcapsules containing an electron-donating colorless dye. Japanese Patent Laid-Open No. 3-72358 discloses that ultraviolet exposure retards the diffusion of the electron-accepting polymerizable vinyl monomer and thereby prevents contact with an electron-donating dye precursor. Thus, even heating after the ultraviolet exposure does not cause coloring of a cured portion.

Japanese Patent Laid-Open No. 2003-012609 discloses a polymerizable phenol derivative with high polymerization reactivity and storage stability in a system for converting a photo-cured polymer image into a visible image by heat development, a photopolymerizable composition containing the derivative, and a recording material.

Japanese Patent Laid-Open No. 2020-142513 discloses a thermosensitive recording medium that has fewer troubles, such as background fogging, during storage before image formation and can form an image with high color developability.

### SUMMARY

The present disclosure provides a thermosensitive recording medium that can prevent coloring due to heating after ultraviolet radiation even when the amount of ultraviolet radiation is small. The present disclosure also provides an image-forming method using the thermosensitive recording medium.

An aspect of the present disclosure provides a thermosensitive recording medium including a thermosensitive coloring layer containing an electron-donating dye precursor, a radical photopolymerization initiator, and an electron-accepting compound with a radical polymerizable group,

wherein the electron-accepting compound with a radical polymerizable group includes a compound A represented by the formula (1):

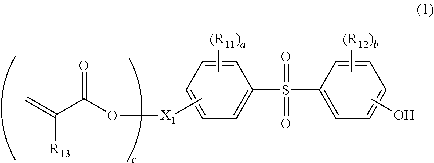

wherein R₁₁ and R₁₂ independently denote a hydrocarbon group having 1 to 8 carbon atoms,

R₁₃ denotes a hydrogen atom or a methyl group,

X₁ denotes a single bond or a hydrocarbon group having 1 to 50 carbon atoms,

a methylene group in the group denoted by X₁ is optionally substituted with a heterocycle, —NHCOO—, —NHCO—, —O—, —CO—, —COO—, or —NR₁₄—,

R₁₄ denotes a hydrogen atom or a hydrocarbon group having 1 to 8 carbon atoms,

a and b independently denote an integer in the range of 0 to 4, and

c denotes an integer in the range of 1 to 10.

Another aspect of the present disclosure provides an image-forming method including the step of heating the thermosensitive recording medium to form an image.

Further features of the present disclosure will become apparent from the following description of exemplary embodiments with reference to the attached drawings.

### BRIEF DESCRIPTION OF THE DRAWINGS

FIG. 1 is a cross-sectional view of a thermosensitive recording medium according to an embodiment of the present disclosure.

FIG. 2 is a cross-sectional view of a thermosensitive recording medium according to another embodiment of the present disclosure.

### DESCRIPTION OF THE EMBODIMENTS

Studies by the present inventors show that the photosensitive/thermosensitive recording materials disclosed in Japanese Patent Laid-Open No. 3-72358, No. 2003-012609, and No. 2020-142513 require a certain integrated light quantity (approximately 1,000 mJ/cm² or more) to prevent coloring after ultraviolet radiation. To downsize an ultraviolet irradiation apparatus and decrease power consumption, it is necessary to further decrease the amount of ultraviolet radiation.

### <Thermosensitive Recording Medium>

The present disclosure is described in detail below with reference to preferred embodiments. However, the present disclosure is not limited to these embodiments. A thermosensitive recording medium according to the present disclosure is a thermosensitive recording medium including a thermosensitive coloring layer containing an electron-donating dye precursor, a radical photopolymerization initiator, and an electron-accepting compound with a radical polymerizable group.

The electron-accepting compound with a radical polymerizable group includes a compound A ((meth)acrylate compound A) represented by the formula (1):

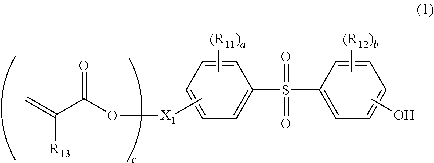

wherein R₁₁ and R₁₂ independently denote a hydrocarbon group having 1 to 8 carbon atoms,

R₁₃ denotes a hydrogen atom or a methyl group,

X₁ denotes a single bond or a hydrocarbon group having 1 to 50 carbon atoms,

a methylene group in the group denoted by X₁ is optionally substituted with a heterocycle, —NHCOO—, —NHCO—, —O—, —CO—, —COO—, or —NR₁₄—,

R₁₄ denotes a hydrogen atom or a hydrocarbon group having 1 to 8 carbon atoms,

a and b independently denote an integer in the range of 0 to 4, and

c denotes an integer in the range of 1 to 10.

The term “(meth)acrylate compound” refers to “acrylate” and “methacrylate”.

In the present disclosure, the electron-accepting compound with a radical polymerizable group has in its molecule both a structure serving as an electron-accepting compound (developer) that comes into contact with an electron-donating dye precursor and develops color and a structure serving as a radical polymerizable compound that reacts with a radical polymerizable initiator and initiates a polymerization reaction. This makes easy to fix the electron-accepting compound with a radical polymerizable group in an ultraviolet cured product. Thus, even at a low ultraviolet irradiation quantity, the electron-accepting compound with a radical polymerizable group is less likely to move in the thermosensitive recording layer, and coloring due to contact with an electron-donating dye precursor while heating can be prevented.

### Electron-Donating Dye Precursor

The thermosensitive coloring layer contains an electron-donating dye precursor (a leuco colorant). The electron-donating dye precursor is typically colorless or pale. The electron-donating dye precursor has a property of donating an electron or accepting a proton from an acid or the like and thereby developing color. Specific examples of the electron-donating dye precursor are described below.

Examples of the electron-donating dye precursor that can produce a red or vermilion color tone include 3,6-bis(diethylamino)fluoran-γ-anilinolactam, 3,6-bis(diethylamino)fluoran-γ-(p-nitro)anilinolactam, 3,6-bis(diethylamino)fluoran-γ-(o-chloro)anilinolactam, 3-dimethylamino-7-bromofluoran, 3-diethylaminofluoran, 3-diethylamino-6-methylfluoran, 3-diethylamino-7-methylfluoran, 3-diethylamino-7-chlorofluoran, 3-diethylamino-7-bromofluoran, 3-diethylamino-7,8-benzofluoran, 3-diethylamino-6,8-dimethylfluoran, and 3-diethylamino-6-methyl-7-chlorofluoran, 3-diethylamino-7-tert-butylfluoran, 3-(N-ethyl-N-tolylamino)-7-ethylfluoran, 3-(N-ethyl-N-isobutylamino)-6-methyl-7-chlorofluoran.

Other examples of the electron-donating dye precursor that can produce a red or vermilion color tone include 3-cyclohexylamino-6-chlorofluoran, 3-di(n-butyl)amino-6-methyl-7-bromofluoran, 3-di(n-butyl)amino-7,8-benzofluoran, 3-tolylamino-7-methylfluoran, 3-tolylamino-7-ethylfluoran, 2-(N-acetylanilino)-3-methyl-6-di(n-butyl)aminofluoran, 2-(N-propionylanilino)-3-methyl-6-di(n-butyl)aminofluoran, 2-(N-benzoylanilino)-3-methyl-6-di(n-butyl)aminofluoran, 2-(N-carbobutoxyanilino)-3-methyl-6-di(n-butyl)aminofluoran, 2-(N-formylanilino)-3-methyl-6-di(n-butyl)aminofluoran, 2-(N-benzylanilino)-3-methyl-6-di(n-butyl)aminofluoran, 2-(N-allylanilino)-3-methyl-6-di(n-butyl)aminofluoran, 2-(N-methylanilino)-3-methyl-6-di(n-butyl)aminofluoran, 3-diethylamino-7-phenoxyfluoran, and 2-methyl-6-(N-p-tolyl-N-ethylamino)-fluoran.

Examples of the electron-donating dye precursor that can produce a magenta color tone include 3,3-bis(1-ethyl-2-methylindol-3-yl)phthalide, 3,3-bis(1-n-octyl-2-methylindol-3-yl)phthalide, 7-(N-ethyl-N-isoamylamino)-3-methyl-1-phenylspiro[(1,4-dihydrochromeno[2,3-c]pyrazole)-4,3′-phthalide], 7-(N-ethyl-N-isoamylamino)-3-methyl-1-p-methylphenylspiro[(1,4-dihydrochromeno[2,3-c]pyrazole)-4,3′-phthalide], and 7-(N-ethyl-N-n-hexylamino)-3-methyl-1-phenylspiro[(1,4-dihydrochromeno[2,3-c]pyrazole)-4,3′-phthalide].

Examples of the electron-donating dye precursor that can produce a magenta color tone include 3-(N-ethyl-N-isoamylamino)-7,8-benzofluoran, 3,3-bis(I-n-butyl-2-methylindol-3-yl)phthalide, and 3-(N-ethyl-N-isoamylamino)-7-phenoxyfluoran.

The electron-donating dye precursor that can produce a red, vermilion, or magenta color tone can be at least one selected from the group consisting of 3-diethylamino-7-chlorofluoran, 3-diethylamino-6,8-dimethylfluoran, 3-(N-ethyl-N-isoamylamino)-7,8-benzofluoran, 2-methyl-6-(N-p-tolyl-N-ethylamino)-fluoran, 3-di(n-butyl)amino-6-methyl-7-bromofluoran, and 3,3-bis(1-n-butyl-2-methylindol-3-yl)phthalide.

Examples of the electron-donating dye precursor that can produce a blue color tone include 3,3-bis(p-dimethylaminophenyl)-6-dimethylaminophthalide, 3-(4-diethylamino-2-methylphenyl)-3-(4-dimethylaminophenyl)-6-dimethylaminophthalide, 3-(4-diethylamino-2-ethoxyphenyl)-3-(1-ethyl-2-methylindol-3-yl)-4-azaphthalide, 3-(1-ethyl-2-methylindol-3-yl)-3-(4-diethylaminophenyl)phthalide, 3-(1-ethyl-2-methylindol-3-yl)-3-(2-methyl-4-diethylaminophenyl)-4-azaphthalide, 3-(1-ethyl-2-methylindol-3-yl)-3-(2-ethoxy-4-diethylaminophenyl)-4-azaphthalide, 3-(1-ethyl-2-methylindol-3-yl)-3-(2-n-hexyloxy-4-diethylaminophenyl)-4-azaphthalide, and 3-diphenylamino-6-diphenylaminofluoran.

Examples of the electron-donating dye precursor that can produce a cyan color tone include 3-(1-ethyl-2-methylindol-3-yl)-3-(4-diethylamino-2-methylphenyl)-4-azaphthalide, 3-[1,1-bis(p-diethylaminophenyl)ethylene-2-yl]-6-dimethylaminophthalide, 3,3-bis(4-diethylamino-2-ethoxyphenyl)-4-azaphthalide, and 3,3′-bis(4-diethylamino-2-ethoxyphenyl)-4-azaphthalide.

The electron-donating dye precursor that can produce a blue or cyan color tone can be at least one selected from the group consisting of 3,3-bis(p-dimethylaminophenyl)-6-dimethylaminophthalide, 3-(4-diethylamino-2-methylphenyl)-3-(4-dimethylaminophenyl)-6-dimethylaminophthalide, 3-(4-diethylamino-2-ethoxyphenyl)-3-(1-ethyl-2-methylindol-3-yl)-4-azaphthalide, 3-(1-ethyl-2-methylindol-3-yl)-3-(4-diethylamino-2-methylphenyl)-4-azaphthalide, 3-(1-ethyl-2-methylindol-3-yl)-3-(2-n-hexyloxy-4-diethylaminophenyl)-4-azaphthalide, 3-[1,1-bis(p-diethylaminophenyl)ethylene-2-yl]-6-dimethylaminophthalide, and 3,3′-bis(4-diethylamino-2-ethoxyphenyl)-4-azaphthalide.

Examples of the electron-donating dye precursor that can produce a yellow color tone include 4-[2-[2-(butoxy)phenyl]-6-phenyl-4-pyridinyl]-N,N-dimethylbenzenamine, 4-[2-[2-(octyloxy)phenyl]-6-phenyl-4-pyridinyl]-N,N-dimethylbenzenamine, 4-[2-[2-(ethoxy)phenyl]-6-phenyl-4-pyridinyl]-N,N-dimethylbenzenamine, 4-[2,6-bis(2-ethoxyphenyl)-4-pyridinyl]-N,N-dimethylbenzenamine, 4-(2,6-diphenyl-4-pyridinyl)-N,N-dimethylbenzenamine, 4-[2,6-bis(2-butoxyphenyl)-4-pyridinyl]-N,N-dimethylbenzenamine, 4-[2,6-bis(2-octyloxyphenyl)-4-pyridinyl]-N,N-dimethylbenzenamine, 4-[2-[2-(hexyloxy)phenyl]-6-phenyl-4-pyridinyl]-N,N-dimethylbenzenamine, 4-[2,6-bis(2-hexyloxyphenyl)-4-pyridinyl]-N,N-dimethylbenzenamine, 3,6-dimethoxyfluoran, and 1-(4-n-dodecyloxy-3-methoxyphenyl)-2-(2-quinolyl)ethylene.

The electron-donating dye precursor that can produce a yellow color tone can be at least one selected from the group consisting of 4-[2-[2-(octyloxy)phenyl]-6-phenyl-4-pyridinyl]-N,N-dimethylbenzenamine, 3,6-dimethoxyfluoran, and 1-(4-n-dodecyloxy-3-methoxyphenyl)-2-(2-quinolyl)ethylene.

Examples of the electron-donating dye precursor that can produce a green color tone include 3-(N-ethyl-N-n-hexylamino)-7-anilinofluoran, 3-diethylamino-7-dibenzylaminofluoran, 3-pyrrolidino-7-dibenzylaminofluoran, 3,3-bis(4-diethylamino-2-ethoxyphenyl)-4-azaphthalide, 3-(N-ethyl-N-p-tolylamino)-7-(N-phenyl-N-methylamino)fluoran, 3-[p-(p-anilinoanilino)anilino]-6-methyl-7-chlorofluoran, and 3,6-bis(dimethylamino)fluorene-9-spiro-3′-(6′-dimethylamino)phthalide.

The electron-donating dye precursor that can produce a green color tone can be at least one selected from the group consisting of 3-diethylamino-7-dibenzylaminofluoran and 3-pyrrolidino-7-dibenzylaminofluoran.

Examples of the electron-donating dye precursor that can produce a black color tone include 3-pyrrolidino-6-methyl-7-anilinofluoran, 3-diethylamino-7-(m-trifluoromethylanilino)fluoran, 3-diethylamino-6-methyl-7-(m-methylanilino)fluoran, 3-(N-isoamyl-N-ethylamino)-7-(o-chloroanilino)fluoran, 3-(N-ethyl-p-toluidino)-6-methyl-7-anilinofluoran, 3-(N-ethyl-N-2-tetrahydrofurfurylamino)-6-methyl-7-anilinofluoran, 3-diethylamino-6-chloro-7-anilinofluoran, 3-di(n-butyl)amino-6-methyl-7-anilinofluoran, 3-di(n-amyl)amino-6-methyl-7-anilinofluoran, 3-(N-isoamyl-N-ethylamino)-6-methyl-7-anilinofluoran, 3-(N-n-hexyl-N-ethylamino)-6-methyl-7-anilinofluoran, 3-[N-(3-ethoxypropyl)-N-ethylamino]-6-methyl-7-anilinofluoran, 3-[N-(3-ethoxypropyl)-N-methylamino]-6-methyl-7-anilinofluoran, 3-diethylamino-7-(2-chloroanilino)fluoran, 3-di(n-butyl)amino-7-(2-chloroanilino)fluoran, 3-diethylamino-6-methyl-7-anilinofluoran, 3-diethylamino-6-methyl-7-(2,6-dimethylanilino)fluoran, 3-diethylamino-6-methyl-7-(2,4-dimethylanilino)fluoran, 2,4-dimethyl-6-(4-dimethylaminoanilino)fluoran, and 3-(N-cyclohexyl-N-methylamino)-6-methyl-7-anilinofluoran.

The electron-donating dye precursor that can produce a black color tone can be at least one with relatively high light resistance selected from the group consisting of 3-di(n-butyl)amino-6-methyl-7-anilinofluoran, 3-di(n-amyl)amino-6-methyl-7-anilinofluoran, 3-diethylamino-6-methyl-7-(2,6-dimethylanilino)fluoran, 3-diethylamino-6-methyl-7-(2,4-dimethylanilino)fluoran, and 2,4-dimethyl-6-(4-dimethylaminoanilino)fluoran.

Examples of the electron-donating dye precursor with absorption in the near-infrared region include 3,3-bis[1,1-bis(4-pyrrolidinophenyl)ethylene-2-yl]-4,5,6,7-tetrabromophthalide, 3,3-bis[1-(4-methoxyphenyl)-1-(4-dimethylaminophenyl)ethylene-2-yl]-4,5,6,7-tetrachlorophthalide, 3,3-bis[1-(4-methoxyphenyl)-1-(4-pyrrolidinophenyl)ethylene-2-yl]-4,5,6,7-tetrachlorophthalide, 3-[p-(p-anilinoanilino)anilino]-6-methyl-7-chlorofluoran, 3-[p-(p-dimethylaminoanilino)anilino]-6-methyl-7-chlorofluoran, 3,6-bis(dimethylamino)fluorene-9-spiro-3′-(6′-dimethylamino)phthalide, bis(p-dimethylaminostyryl)-p-tolylsulfonylmethane, 3-[p-(p-dimethylaminoanilino)anilino]-6-methylfluoran, 3-di(n-pentyl)amino-6,8,8-trimethyl-8,9-dihydro-(3,2,e)pyridofluoran, 3-di(n-butyl)amino-6,8,8-trimethyl-8,9-dihydro-(3,2,e)pyridofluoran, 3-(p-n-butylaminoanilino)-6-methyl-7-chlorofluoran, and 2-mesidino-8-diethylaminobenzo[c]fluoran.

The electron-donating dye precursor content of the thermosensitive coloring layer preferably ranges from 0.01 to 2.00 g/m² to form an image with a more sufficient optical density.

### Radical Photopolymerization Initiator

The thermosensitive coloring layer contains a radical photopolymerization initiator. The radical photopolymerization initiator may be a compound that can produce a radical by the action of light. The radical photopolymerization initiator may be a known compound such as a radical generator, a radical polymerization initiator, or a radical photopolymerization initiator.

For an efficient curing reaction by ultraviolet radiation, examples of the radical photopolymerization initiator include oxime ester compounds, aromatic ketone compounds, acylphosphine oxide compounds, benzoin alkyl ether compounds, benzoin ether compounds, thioxanthone compounds, benzophenone compounds, benzoate compounds, aromatic onium salt compounds, organic peroxides, thio compounds (such as compounds with a thiophenyl group), α-aminoalkylphenone compounds, hexaaryl biimidazole compounds, borate compounds, azinium compounds, metallocene compounds, active ester compounds, compounds with a carbon-halogen bond, and alkylamine compounds. Radical generators described in Japanese Patent Laid-Open No. 2018-35369 and No. 2018-39265 may also be used. Among them, aromatic ketone compounds, oxime ester compounds, acylphosphine oxide compounds, benzoin alkyl ether compounds, benzoin ether compounds, thioxanthone compounds, benzophenone compounds, and benzoate compounds can be used. In particular, oxime ester compounds can be used.

These radical photopolymerization initiators may be used alone or in combination. The radical photopolymerization initiator content of the thermosensitive coloring layer preferably ranges from 10% to 200% by mass, more preferably 25% to 100% by mass, of the electron-accepting compound with a radical polymerizable group.

Examples of the oxime ester compounds include 1,2-octanedione,1-[4-(phenylthio)phenyl]-,2-(o-benzoyloxime), ethanone,1-[9-ethyl-6-(2-ethylbenzoyl)-9H-carbazol-3-yl]-,1-(o-acetyloxime), (9-ethyl-6-nitro-9H-carbazole-3-yl)-(4-((1-methoxypropan-2-yl)oxy)-2-methylphenyl)methanone-o-acetyl oxime, and 1-[4-[[4-(2-hydroxyethoxy)phenyl]thio]phenyl-1]-1,2-propanedione-2-(o-acetyl oxime).

Examples of the aromatic ketone compounds include acetophenone, 2-hydroxy-2-methyl-1-phenyl-1-propanone, 2,2-diethoxyacetophenone, 2,2-dimethoxy-2-phenylacetophenone, 4-methylbenzophenone, 2,2′-phenylp-tert-butyltrichloroacetophenone, p-tert-butyldichloroacetophenone, benzophenone, 4-phenylbenzophenone, methyl benzoylformate, 4-[(4-methylphenyl)thio]benzophenone, 4,4′-bis(diethylamino)benzophenone, N,N′-tetramethyl-4,4′-diaminobenzophenone (Michler's ketone), 1-hydroxycyclohexyl phenyl ketone, 1-[4-(2-hydroxyethoxy)-phenyl]-2-hydroxy-2-methylpropane, 2-benzyl-2-dimethylamino-1-(4-morpholinophenyl)-butanone-1,2-methyl-[4-(methylthio)phenyl]-2-morpholino-1-propane, 2-(dimethylamino)-2-[(4-methylphenyl)methyl]-1-[4-(4-morpholinyl)phenyl]-1-butanone, and 2-hydroxy-1-{4-[4-(2-hydroxy-2-methyl-propionyl)-benzyl]-phenyl}-2-methyl-propan-1-one.

Examples of the acylphosphine oxide compounds include 2,4,6-trimethylbenzoyl diphenylphosphine oxide and bis(2,4,6-trimethylbenzoyl)-diphenylphosphine oxide.

Examples of the benzoin alkyl ether compounds include benzoin methyl ether, benzoin ethyl ether, benzoin butyl ether, and benzoin isopropyl ether.

Examples of the benzoin ether compounds include methylbenzoin and ethylbenzoin.

Examples of the thioxanthone compounds include 2-chlorothioxanthone, 2,4-diethylthioxanthone, isopropylthioxanthone, and 2-methylthioxanthone.

Examples of the benzophenone compounds include benzophenone, 4-methylbenzophenone, 4-phenylbenzophenone, 4-(4-methylphenylthio)benzophenone, and 4,4′-bis(diethylamino)benzophenone.

Examples of the benzoate compounds include ethyl-4-(dimethylamino)-benzoate, ethylhexyl-4-dimethylaminobenzoate, methyl-o-benzoylbenzoate, and 3-methylbutyl p-(dimethylamino)benzoate.

Examples of commercially available oxime ester compounds, which are radical photopolymerization initiators, include Irgacure OXE01 manufactured by BASF Japan Ltd., Irgacure OXE02 manufactured by BASF Japan Ltd., Irgacure OXE03 manufactured by BASF Japan Ltd., Irgacure OXE04 manufactured by BASF Japan Ltd., Adeka Arcs N-1919 manufactured by ADEKA Co., Ltd., Adeka Arcs NCI-831 manufactured by ADEKA Co., Ltd., and Adeka Arcs NCI-930 manufactured by ADEKA Co., Ltd.

Electron-Accepting Compound with Radical Polymerizable Group

The thermosensitive coloring layer contains an electron-accepting compound with a radical polymerizable group. The electron-accepting compound with a radical polymerizable group has in its molecule both a structure serving as an electron-accepting compound (developer) that comes into contact with an electron-donating dye precursor and develops color and a structure serving as a radical polymerizable compound that reacts with a radical polymerizable initiator and initiates a polymerization reaction.

The mechanism is described in detail below.

Heating the thermosensitive recording medium brings the electron-donating dye precursor contained in the thermosensitive coloring layer into contact with the electron-accepting compound with a radical polymerizable group and causes a reaction therebetween, thereby developing color in the heated portion and forming an image. However, reheating the thermosensitive recording medium on which an image is formed may cause coloring of an uncolored region. Thus, a method for forming an image on a thermosensitive recording medium can be an image-forming method including the step of applying a heat pulse to the thermosensitive recording medium using a thermal head to form an image and the step of irradiating the thermosensitive recording medium on which the image is formed with ultraviolet radiation to fix a thermosensitive coloring layer. In this image-forming method, the thermosensitive coloring layer in the thermosensitive recording medium can contain a radical photopolymerization initiator and an electron-accepting compound with a radical polymerizable group. In the image-forming method, first, the thermosensitive coloring layer in a region to be colored is heated with the thermal head.

A region not heated with the thermal head does not develop color. An image is formed on the thermosensitive recording medium in accordance with the presence or absence of coloring of the thermosensitive coloring layer. Next, to maintain the coloring state of the thermosensitive coloring layer, the thermosensitive recording medium on which the image is formed is irradiated with ultraviolet radiation. This cleaves a radical photopolymerization initiator in the thermosensitive coloring layer and produces a radical.

The produced radical initiates the propagation of an electron-accepting compound with a radical polymerizable group in the thermosensitive coloring layer and forms a cured product with a three-dimensional network of a cross-linked polymer chain. The electron-accepting compound with a radical polymerizable group is fixed in the cured product. This decreases contact opportunities between the electron-donating dye precursor and the electron-accepting compound with a radical polymerizable group. The electron-accepting compound with a radical polymerizable group is one molecule and is almost impossible to move in the thermosensitive recording layer after curing. This further decreases contact opportunities with the electron-accepting compound. This can prevent coloring of the thermosensitive coloring layer even by heating after ultraviolet radiation, and the coloring state of the thermosensitive coloring layer before ultraviolet radiation can be maintained.

In the present disclosure, the electron-accepting compound with a radical polymerizable group includes a compound A represented by the formula (1):

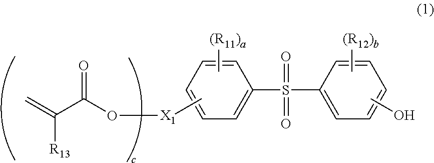

wherein R₁₁ and R₁₂ independently denote a hydrocarbon group having 1 to 8 carbon atoms,

R₁₃ denotes a hydrogen atom or a methyl group,

X₁ denotes a single bond or a hydrocarbon group having 1 to 50 carbon atoms,

a methylene group in the group denoted by X₁ is optionally substituted with a heterocycle, —NHCOO—, —NHCO—, —O—, —CO—, —COO—, or —NR₁₄—,

R₁₄ denotes a hydrogen atom or a hydrocarbon group having 1 to 8 carbon atoms,

a and b independently denote an integer in the range of 0 to 4, and

c denotes an integer in the range of 1 to 10.

Specific examples of the compound A represented by the formula (1) include the following compounds (D-1) to (D-5).

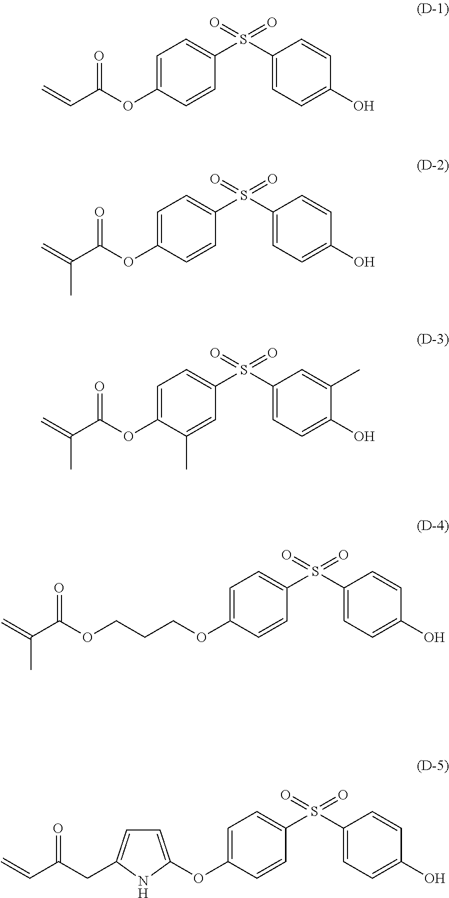

When a methylene group in the group denoted by X₁ in the formula (1), for example, in the compound (D-5) is substituted with a heterocycle, —NHCOO—, —NHCO—, —O—, —CO—, —COO—, or —NR₁₄—, X₁ in the compound (D-5) is a hydrocarbon group having two carbon atoms in which one methylene group is substituted with —O— and the other methylene group is substituted with a pyrrole ring.

For a more efficient curing reaction by ultraviolet radiation, the compound A represented by the formula (1) can be represented by the formula (2). In the formula (2), —NHCOO— (a urethane bond) in the molecule of the (meth)acrylate compound A improves the flexibility of the molecule, accelerates the radical polymerization reaction, and can more efficiently promote the curing reaction.

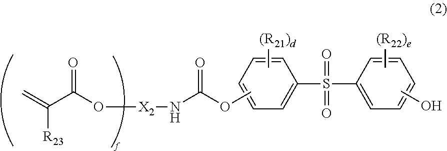

In the formula (2), R₂₁ and R₂₂ independently denote a hydrocarbon group having 1 to 8 carbon atoms,

R₂₃ denotes a hydrogen atom or a methyl group,

X₂ denotes a hydrocarbon group having 1 to 49 carbon atoms,

a methylene group in the group denoted by X₂ is optionally substituted with —NHCOO—, —NHCO—, —O—, —CO—, —COO—, or —NR₂₄—,

R₄ denotes a hydrogen atom or a hydrocarbon group having 1 to 8 carbon atoms,

d and e independently denote an integer in the range of 0 to 4, and

f denotes an integer in the range of 1 to 10.

Specific examples of the compound A represented by the formula (2) include the following compounds (D-6) to (D-38).

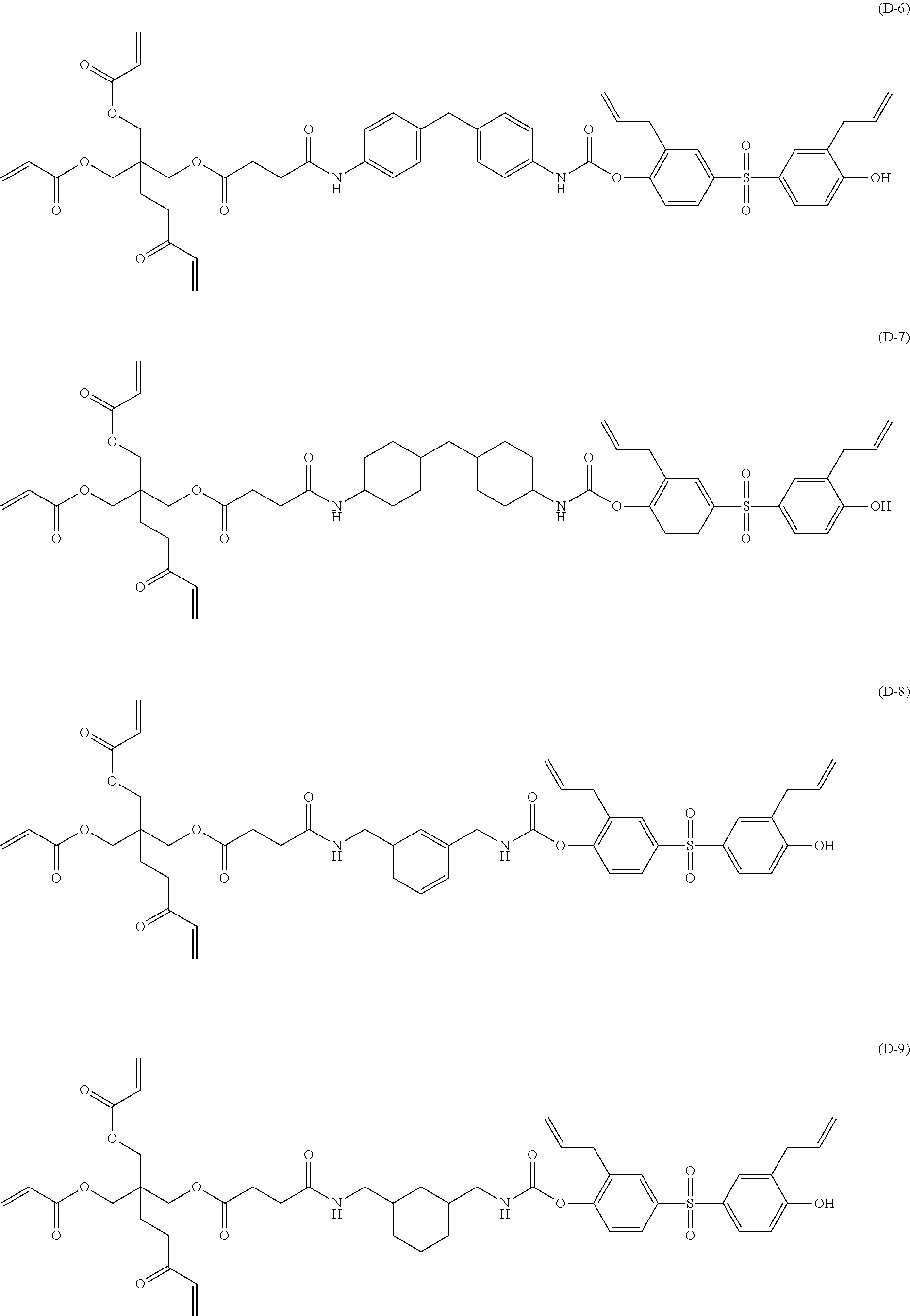

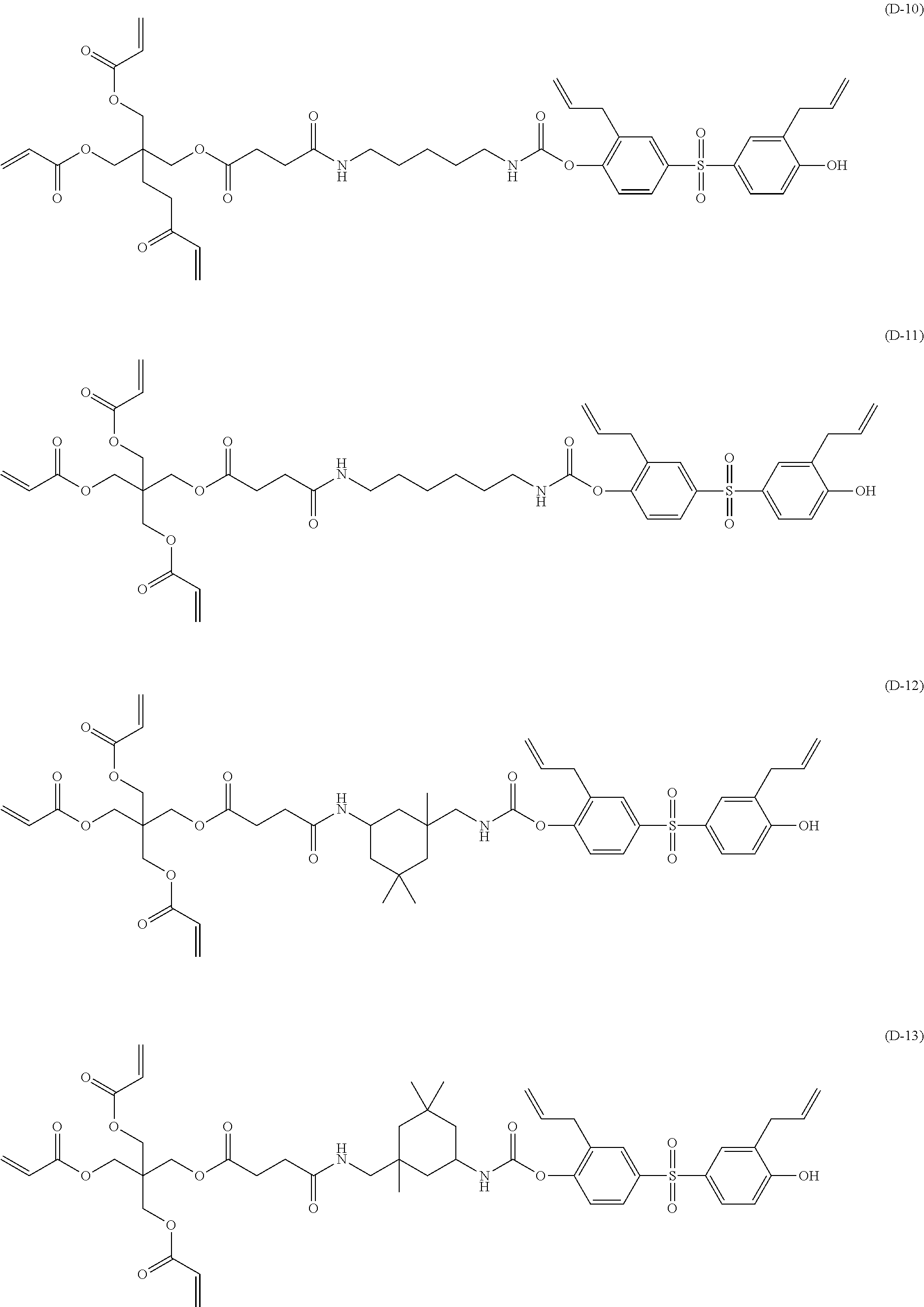

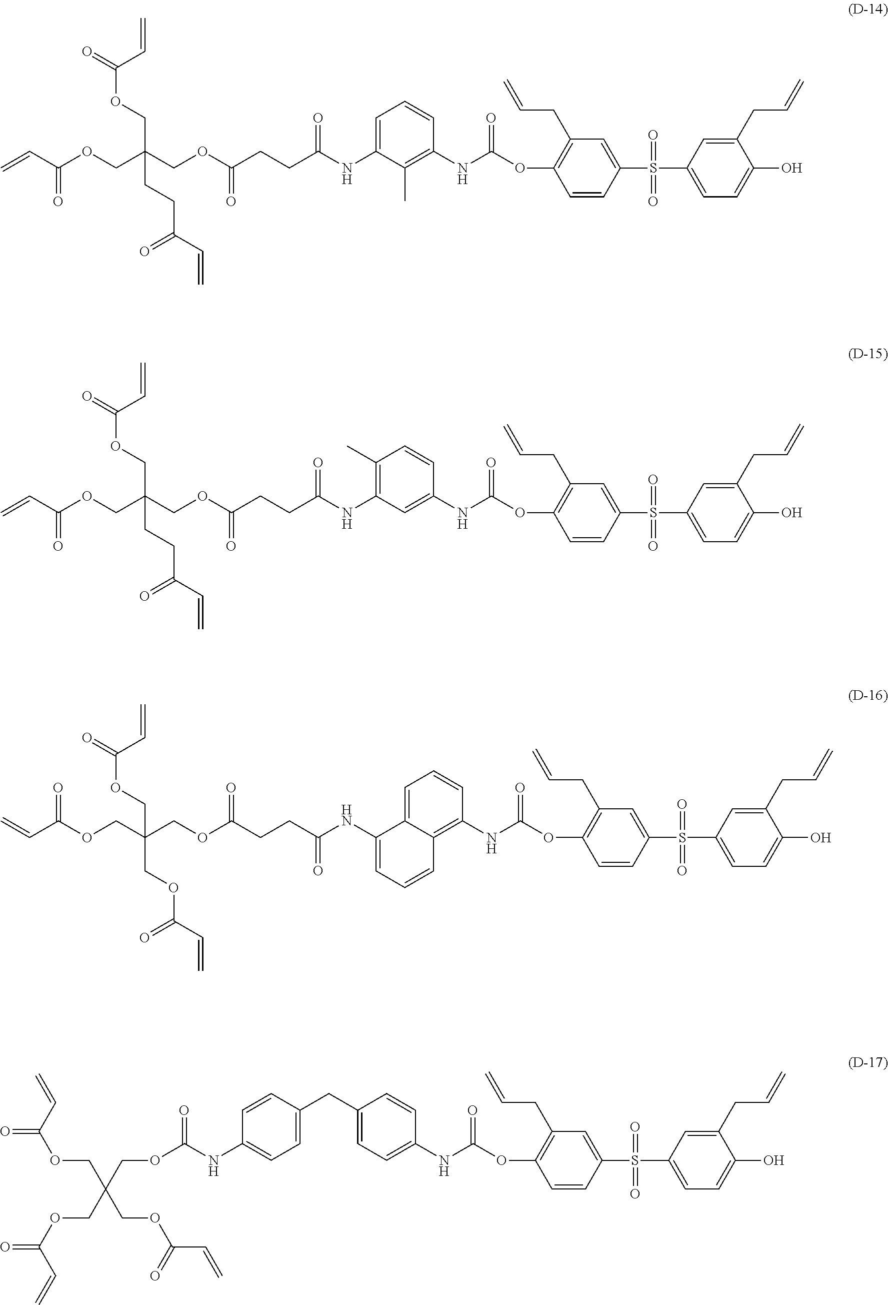

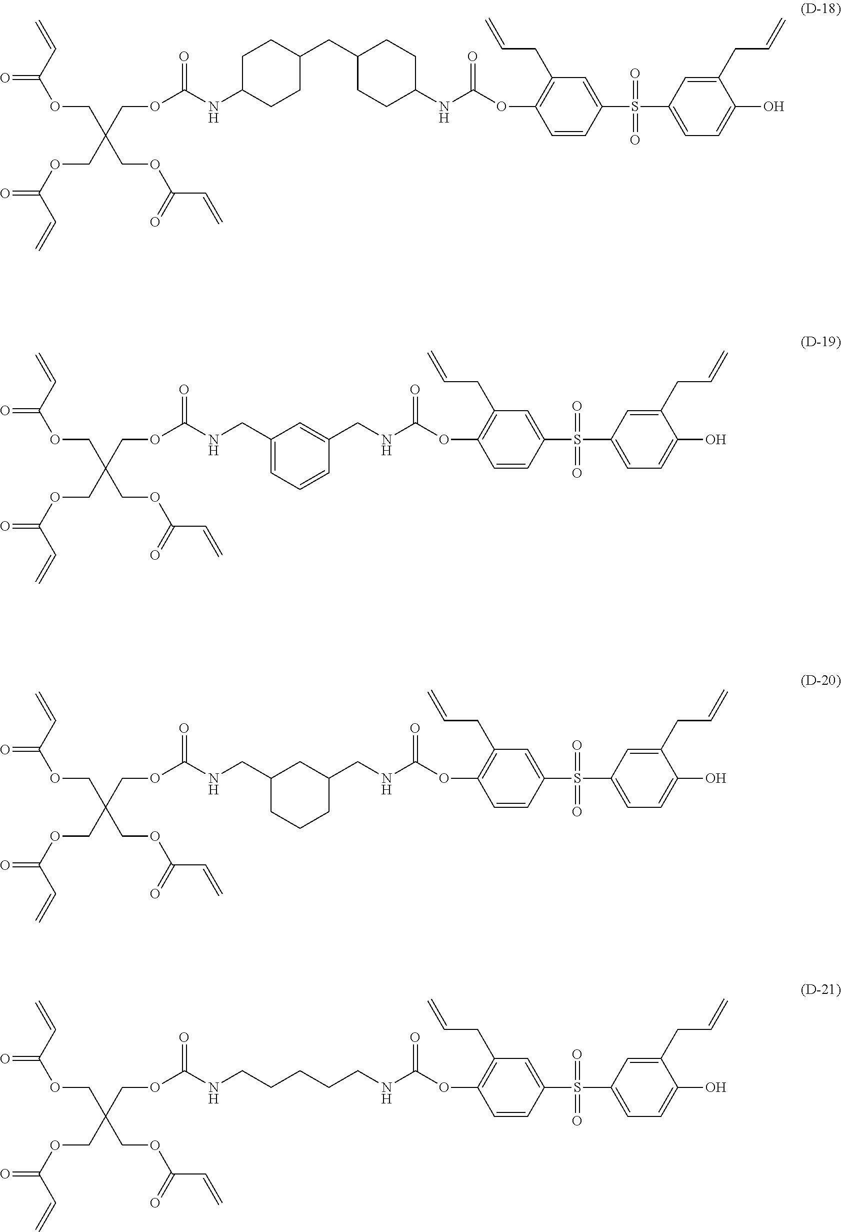 [SMILES: C=CCc1cc(S(=O)(=O)c2ccc(OC(=O)NC3CCC(CC4CCC(NC(=O)OCC(COC(=O)C=C)(COC(=O)C=C)COC(=O)C=C)CC4)CC3)c(CC=C)c2)ccc1O ; C=CCc1cc(S(=O)(=O)c2ccc(OC(=O)NCc3cccc(CNC(=O)OCC(COC(=O)C=C)(COC(=O)C=C)COC(=O)C=C)c3)c(CC=C)c2)ccc1O ; C=CCc1cc(S(=O)(=O)c2ccc(OC(=O)NCC3CCCC(CNC(=O)OCC(COC(=O)C=C)(COC(=O)C=C)COC(=O)C=C)C3)c(CC=C)c2)ccc1O ; C=CCc1cc(S(=O)(=O)c2ccc(OC(=O)NCCCCCNC(=O)OCC(COC(=O)C=C)(COC(=O)C=C)COC(=O)C=C)c(CC=C)c2)ccc1O]

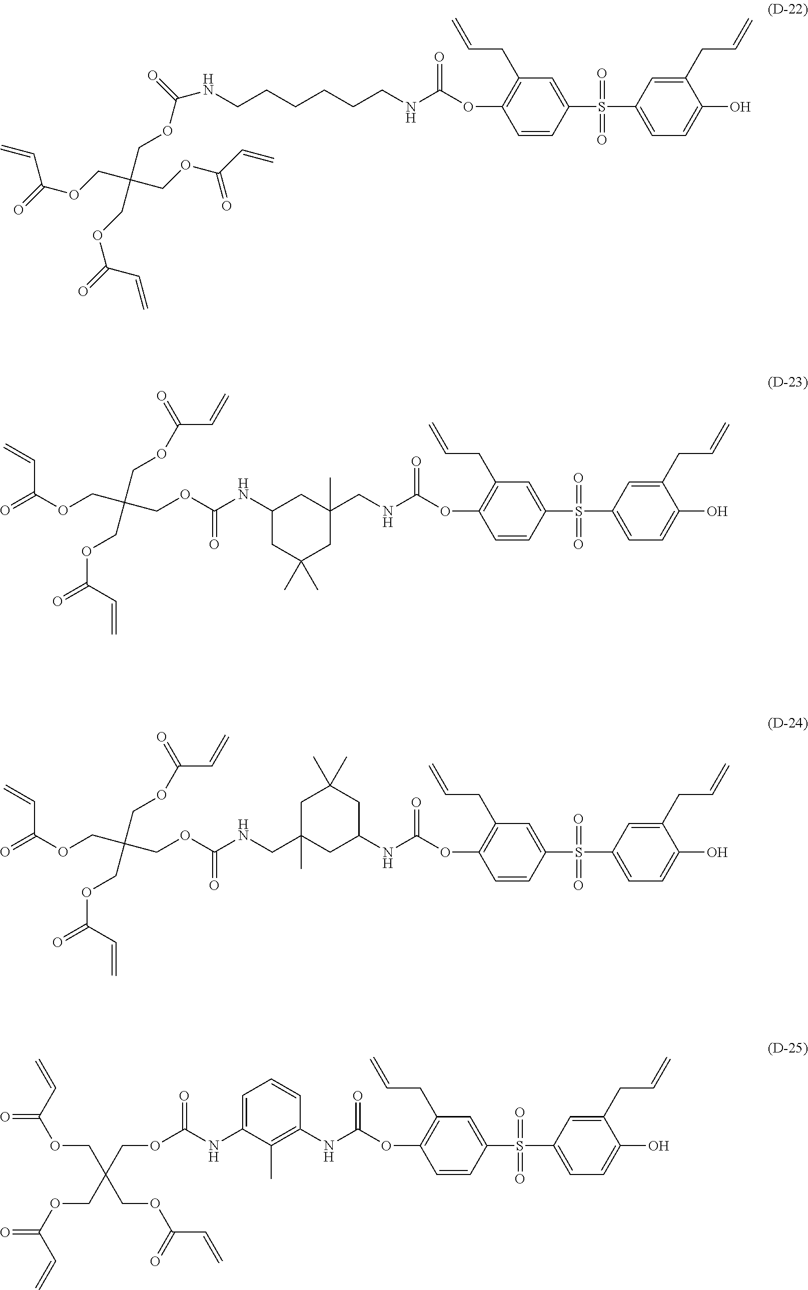 [SMILES: C=CCc1cc(S(=O)(=O)c2ccc(OC(=O)NCCCCCCNC(=O)OCC(COC(=O)C=C)(COC(=O)C=C)COC(=O)C=C)c(CC=C)c2)ccc1O ; C=CCc1cc(S(=O)(=O)c2ccc(OC(=O)NCC3(C)CC(NC(=O)OCC(COC(=O)C=C)(COC(=O)C=C)COC(=O)C=C)CC(C)(C)C3)c(CC=C)c2)ccc1O ; C=CCc1cc(S(=O)(=O)c2ccc(OC(=O)NC3CC(C)(C)CC(C)(CNC(=O)OCC(COC(=O)C=C)(COC(=O)C=C)COC(=O)C=C)C3)c(CC=C)c2)ccc1O ; C=CCc1cc(S(=O)(=O)c2ccc(OC(=O)Nc3cccc(NC(=O)OCC(COC(=O)C=C)(COC(=O)C=C)COC(=O)C=C)c3C)c(CC=C)c2)ccc1O]

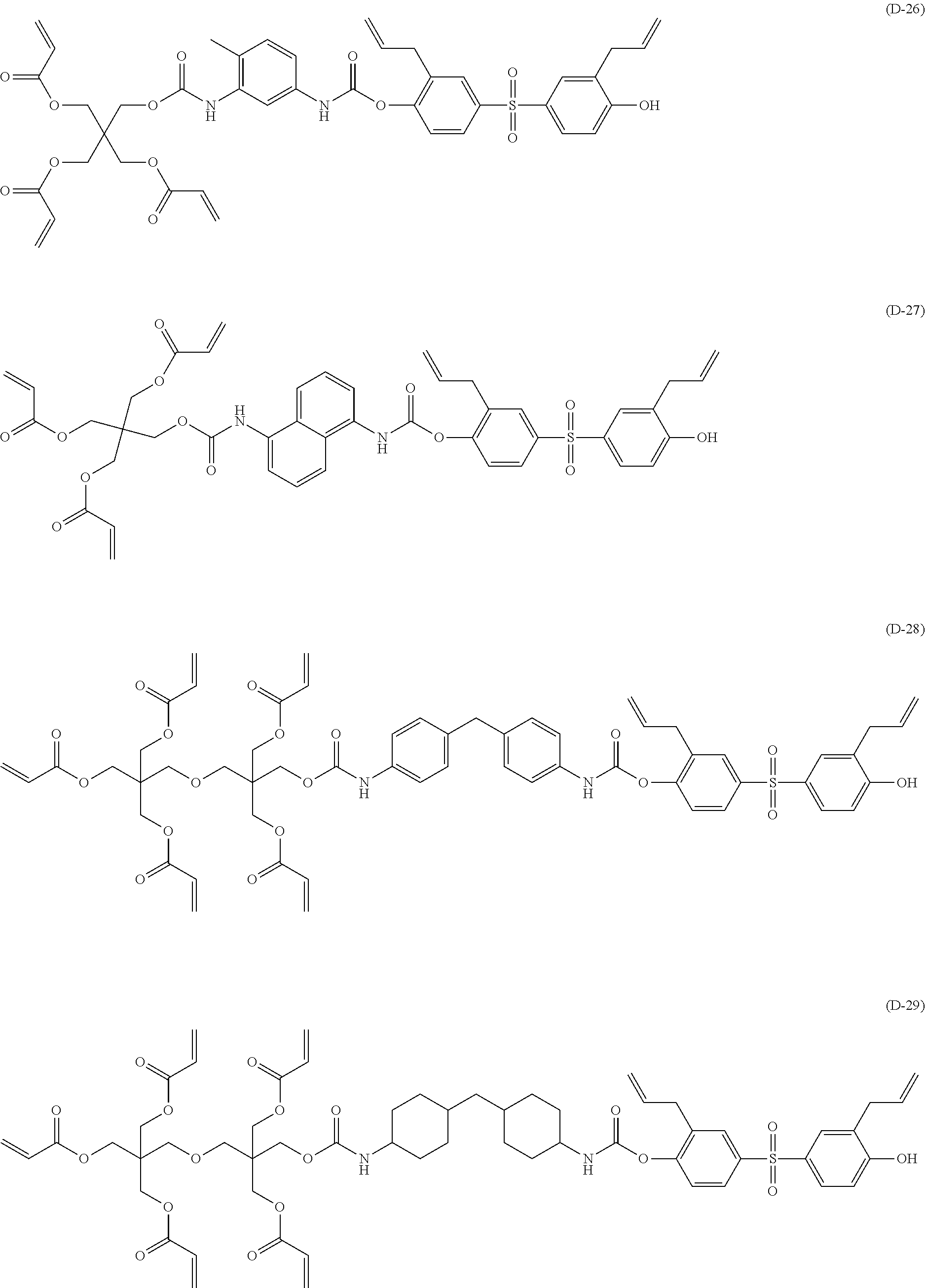

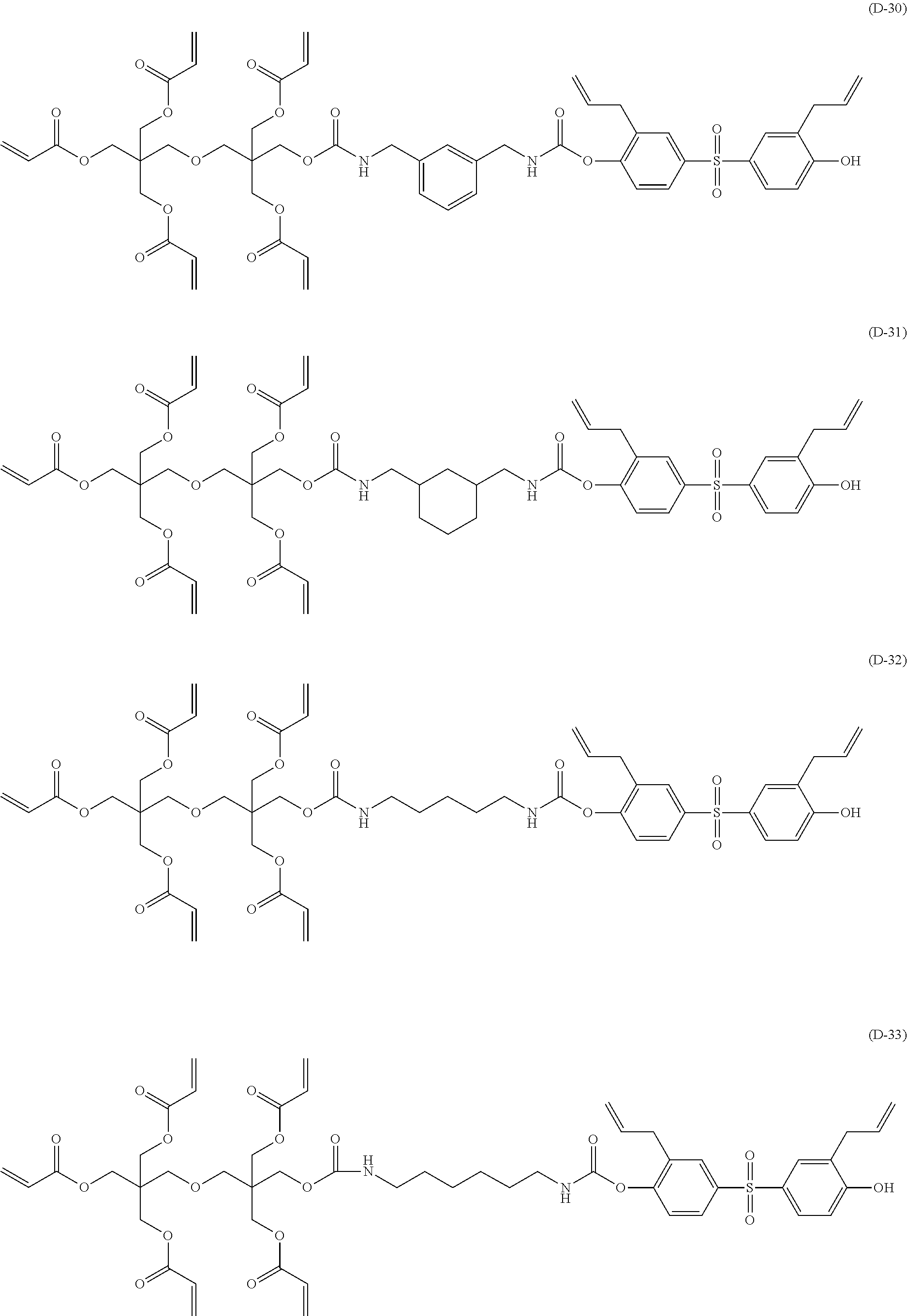

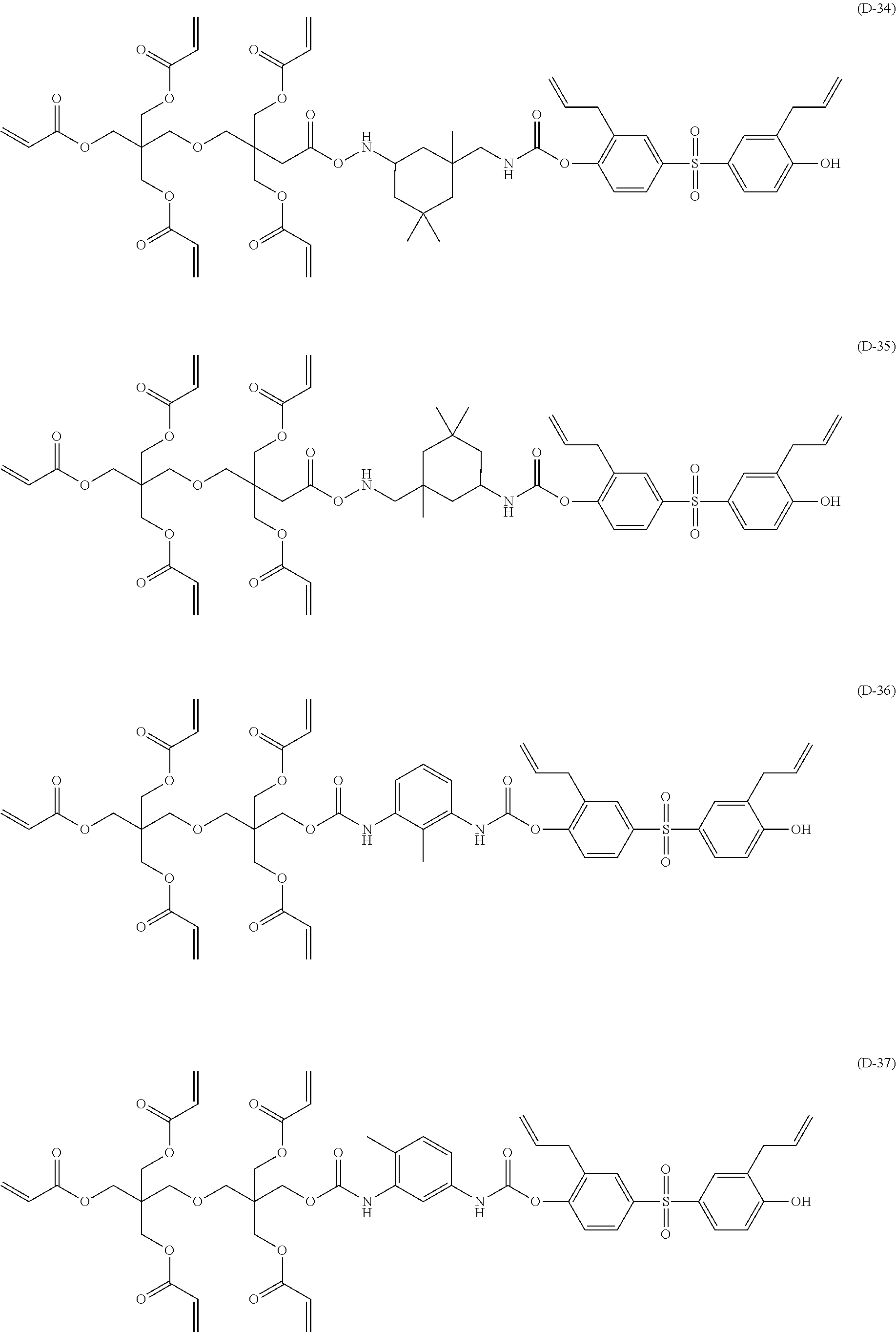

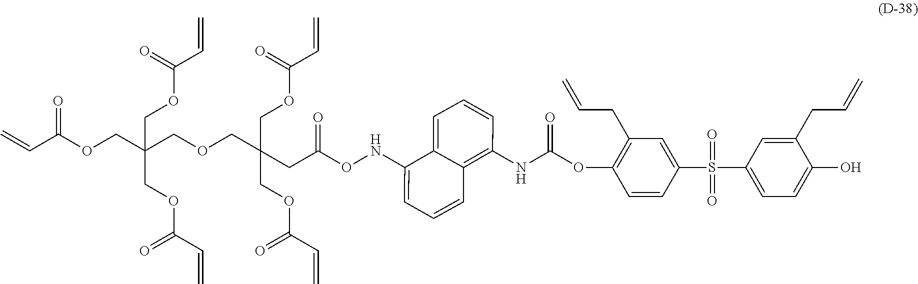 [SMILES: C=CCc1cc(S(=O)(=O)c2ccc(OC(=O)Nc3cccc4c(NOC(=O)CC(COCC(COC(=O)C=C)(COC(=O)C=C)COC(=O)C=C)(COC(=O)C=C)COC(=O)C=C)cccc34)c(CC=C)c2)ccc1O]

For a much more efficient curing reaction by ultraviolet radiation, the compound A represented by the formula (1) can be represented by the formula (3). In the formula (3), when X₃ in the molecule of the (meth)acrylate compound A is a methylene group or a methylene group substituted with —O— (an ether bond), X₃ improves the flexibility of the molecule, further accelerates the radical polymerization reaction, and can more efficiently promote the curing reaction.

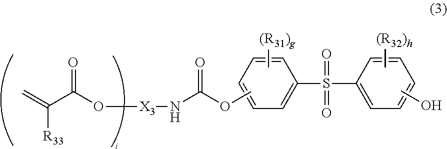

In the formula (3), R₃₁ and R₃₂ independently denote a hydrocarbon group having 1 to 8 carbon atoms,

R₃₃ denotes a hydrogen atom or a methyl group,

X₃ denotes a hydrocarbon group having 1 to 49 carbon atoms,

a methylene group in the group denoted by X₃ is optionally substituted with —O—,

g and h independently denote an integer in the range of 0 to 4, and

i denotes an integer in the range of 1 to 10.

Specific examples of the compound A represented by the formula (3) include the following compounds (D-39) to (D-48).

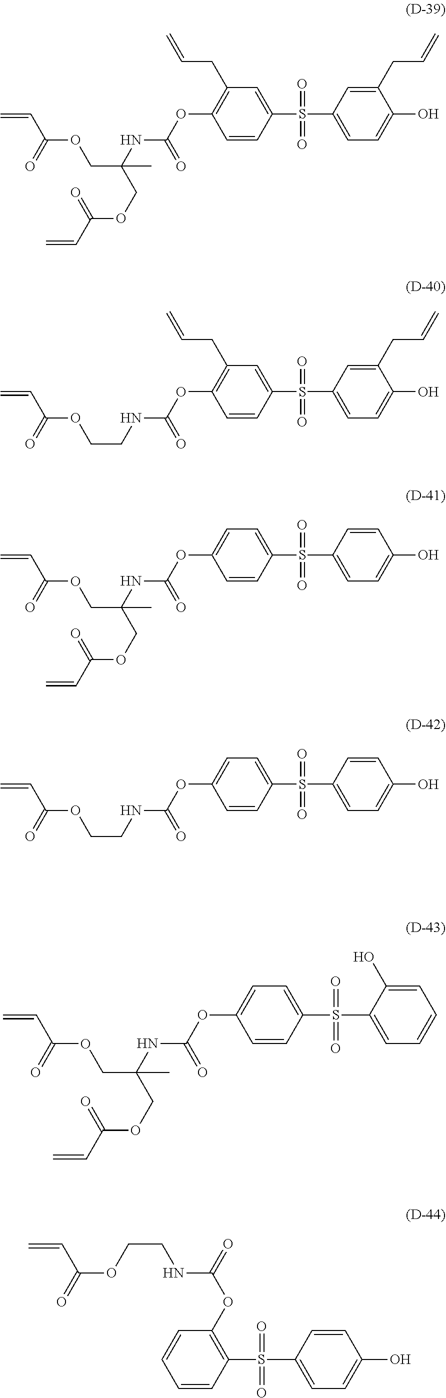

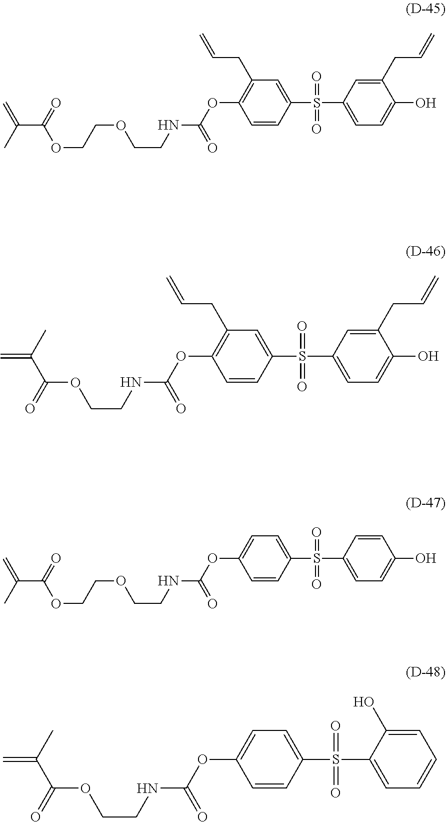

Next, the electron-accepting compound with a radical polymerizable group in the thermosensitive coloring layer is described below. The electron-accepting compound with a radical polymerizable group in the thermosensitive coloring layer may have any form and may be particles or a layer. For example, a thermosensitive coloring layer containing a layer of an electron-accepting compound with a radical polymerizable group can have a first layer containing an electron-donating dye precursor and a second layer containing the electron-accepting compound with a radical polymerizable group. The first layer containing the electron-donating dye precursor is hereinafter also referred to as an “electron-donating dye precursor layer” or a “leuco layer”. The second layer containing the electron-accepting compound with a radical polymerizable group is hereinafter also referred to as an “electron-accepting compound layer with a radical polymerizable group” or a “developer layer”.

The thermosensitive coloring layer can contain particles containing an electron-accepting compound with a radical polymerizable group and a radical photopolymerization initiator. The particles containing an electron-accepting compound with a radical polymerizable group and a radical photopolymerization initiator can be prepared by any method, for example, by an O/W emulsion method. The radical photopolymerization initiator can be mixed in advance with the electron-accepting compound with a radical polymerizable group. The particles containing the electron-accepting compound with a radical polymerizable group and the radical photopolymerization initiator preferably have a particle size in the range of 10 to 1,000 nm, more preferably 50 to 300 nm. The particles with a particle size of 10 nm or more or even 50 nm or more can have high radical polymerization reactivity and improve the storage stability of an image. The particles with a particle size of 1,000 nm or less or even 300 nm or less can reduce unnecessary light scattering in the thermosensitive coloring layer and increase the image density. The term “particle size”, as used herein, refers to the 50% particle size (D50) based on the volume distribution.

The electron-accepting compound with a radical polymerizable group may be used alone or in combination. For efficient curing by ultraviolet radiation, the amount of the electron-accepting compound with a radical polymerizable group in the thermosensitive coloring layer is preferably 500% or more by mass, more preferably 1500% or more by mass, of the amount of the electron-donating dye precursor. The upper limit of the amount of the electron-accepting compound with a radical polymerizable group is not particularly limited but is preferably, for example, 5000% or less by mass of the amount of the electron-donating dye precursor.

### [Method for Synthesizing Compound A Represented by Formula (1)]

A compound A represented by the formula (1) can be obtained as a commercial product. A compound A that is not a commercial product can also be produced by a known synthesis method.

For example, the compounds (D-6) to (D-38) can be produced by a reaction of at least one of the following compounds (a) to (c).

Compound (a): A polyfunctional acrylate compound having at least one —OH or —COOH group in the molecule. Examples of commercial products include SR295 manufactured by Sartomer, SR399 manufactured by Sartomer, and ARONIX M510 manufactured by Toagosei Co., Ltd.

Compound (b): A diisocyanate compound, such as hexamethylene diisocyanate (HDI), diphenylmethane diisocyanate (MDI), 1,5-pentamethylene diisocyanate (PDI), isophorone diisocyanate (IPDI), or toluene diisocyanate (TDI).

Compound (c): An electron-accepting compound with a diphenyl sulfone backbone and two or more OH groups in the molecule. Examples of commercial products include TGSH(H) manufactured by Nippon Kayaku Co., Ltd. and BPS-24C manufactured by Nicca Chemical Co., Ltd.

The compounds (D-39) to (D-48) can be produced, for example, by the scheme of the following method (i).

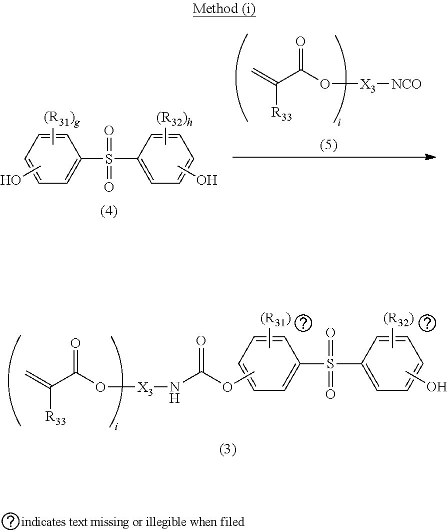

In the formulae (3) to (5), R₃₁ and R₃₂ independently denote a hydrocarbon group having 1 to 8 carbon atoms,

R₃₃ denotes a hydrogen atom or a methyl group,

X₃ denotes a hydrocarbon group having 1 to 49 carbon atoms,

a methylene group in the group denoted by X₃ is optionally substituted with —O—,

g and h independently denote an integer in the range of 0 to 4, and

i denotes an integer in the range of 1 to 10.

A compound represented by the formula (3) can be produced by adding a compound represented by the formula (5) to a compound represented by the formula (4) and by agitation for a predetermined time. A condensation reaction occurs between the —OH group in the compound represented by the formula (4) and the —NCO group in the compound represented by the formula (5).

To react approximately 50% of the —OH group in the compound represented by the formula (4), the amount of the compound represented by the formula (5) to be added preferably ranges from 100% to 150% by mole of the compound represented by the formula (4).

Although the method (i) may be performed without a solvent, the method (i) can be performed in the presence of a solvent to prevent rapid progress of the reaction. Any solvent that does not inhibit the reaction may be used. Examples of the solvent include esters, such as methyl acetate, ethyl acetate, and propyl acetate, ethers, such as diethyl ether, tetrahydrofuran, and dioxane, hydrocarbons, such as benzene, toluene, xylene, hexane, and heptane, and halogen-containing hydrocarbons, such as dichloromethane, dichloroethane, and chloroform. These solvents may be used alone or in combination. For a mixed solvent, the mixing ratio may be determined in accordance with the solubility of the solute. The amount of the solvent to be used may be appropriately determined and, in terms of reaction rate, can range from 100% to 1000% by mass of the compound represented by the formula (4).

The method (i) is typically performed in the temperature range of 20° C. to 100° C. and is typically completed within 48 hours.

Next, the compounds represented by the formulae (4) and (5) are described below. Examples of commercial products of the compound represented by the formula (4) include TGSH(H) manufactured by Nippon Kayaku Co., Ltd. and BPS-24C manufactured by Nicca Chemical Co., Ltd. Examples of commercial products of the compound represented by the formula (5) include Karenz BET manufactured by Showa Denko K.K., Karenz AOI manufactured by Showa Denko K.K., Karenz MOT manufactured by Showa Denko K.K., and Karenz MOI-EG manufactured by Showa Denko K.K.

The molecular structure of the synthesized compound represented by the formula (1) can be identified with a nuclear magnetic resonance spectrometer (NMR), an infrared spectrophotometer (IR), or a mass spectrometer (MS)

### Other Components

The thermosensitive coloring layer may contain a storage stability improving agent. The storage stability improving agent in the thermosensitive coloring layer can further improve the storage stability of a colored image. Examples of the storage stability improving agent include phenolic compounds, such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds, such as 4-benzyloxyphenyl-4′-(2-methyl-2,3-epoxypropyloxy)phenyl sulfone, 4-(2-methyl-1,2-epoxyethyl)diphenyl sulfone, and 4-(2-ethyl-1,2-epoxyethyl)diphenyl sulfone; and isocyanuric acid compounds, such as 1,3,5-tris(2,6-dimethylbenzyl-3-hydroxy-4-tert-butyl)isocyanuric acid.

The thermosensitive coloring layer may contain a thermal sensitizer. The thermal sensitizer in the thermosensitive coloring layer can enhance recording sensitivity. Examples of the thermal sensitizers include stearamide, methoxycarbonyl-N-stearic acid benzamide, N-benzoyl stearamide, N-eicosanoic acid amide, ethylenebisstearamide, behenic acid amide, methylenebisstearamide, N-methylol stearamide, dibenzyl terephthalate, dimethyl terephthalate, dioctyl terephthalate, diphenyl sulfone, benzyl p-benzyloxybenzoate, phenyl 1-hydroxy-2-naphthoate, 2-naphthylbenzyl ether, m-terphenyl, p-benzylbiphenyl, di-p-chlorobenzyl oxalate, di-p-methylbenzyl oxalate, dibenzyl oxalate, p-tolyl biphenyl ether, di(p-methoxyphenoxyethyl) ether, 1,2-di(3-methylphenoxy)ethane, 1,2-di(4-methylphenoxy)ethane, 1,2-di(4-methoxyphenoxy)ethane, 1,2-di(4-chlorophenoxy)ethane, 1,2-diphenoxyethane, 1-(4-methoxyphenoxy)-2-(3-methylphenoxy)ethane, p-methylthiophenyl benzyl ether, 1,4-di(phenylthio)butane, p-acetotoluidide, p-acetophenetidide, N-acetoacetyl-p-toluidine, 1,2-diphenoxymethylbenzene, di(β-biphenylethoxy)benzene, p-di(vinyloxyethoxy)benzene, 1-isopropylphenyl-2-phenylethane, di-o-chlorobenzyl adipate, 1,2-bis(3,4-dimethylphenyl)ethane, 1,3-bis(2-naphthoxy)propane, diphenyl, and benzophenone. The thermal sensitizer content of the thermosensitive coloring layer may be an amount effective for thermal sensitization. More specifically, the thermal sensitizer content preferably ranges from 2% to 40% by mass, more preferably 5% to 25% by mass, of the total solid content of the thermosensitive coloring layer.

Auxiliary agents, such as a storage stability improving agent and a thermal sensitizer, may be mixed in the form of fine particles dispersed in water (solid dispersed fine particles) with a coating liquid for forming the thermosensitive coloring layer. These auxiliary agents may be dissolved in a solvent and may be emulsified using a water-soluble polymer as an emulsifier. Furthermore, the storage stability improving agent and the thermal sensitizer may be contained in particles containing an electron-donating dye precursor and/or an electron-accepting compound.

The thermosensitive coloring layer may contain a polymerization accelerator. The polymerization accelerator may be a benzoate compound or an amine compound.

Examples of the benzoate compound and the amine compound include ethyl-4-(dimethylamino)-benzoate, ethylhexyl-4-dimethylaminobenzoate, methyl-o-benzoylbenzoate, 3-methylbutyl p-(dimethylamino)benzoate, ethyl N,N-dimethylaminobenzoate, isoamyl N,N-dimethylaminobenzoate, pentyl 4-dimethylaminobenzoate, triethylamine, and triethanolamine.

The thermosensitive coloring layer may contain a sensitizer. The sensitizer may be any sensitizer that sensitizes the radical photopolymerization initiator by an electron transfer mechanism or an energy transfer mechanism. Examples of the sensitizer include aromatic poly-fused-ring compounds, such as anthracene, 9,10-dialkoxyanthracene, pyrene, and perylene; aromatic ketone compounds, such as acetophenone, benzophenone, thioxanthone, and Michler's ketone; and heterocyclic compounds, such as phenothiazine and N-aryl oxazolidinone. The sensitizer content of the thermosensitive coloring layer preferably ranges from 10% to 1000% by mass, more preferably 100% to 500% by mass, of the radical photopolymerization initiator content.

To improve the electron transfer efficiency or the energy transfer efficiency between the sensitizer and the radical photopolymerization initiator, the thermosensitive coloring layer can contain a sensitizing auxiliary agent. Examples of the sensitizing auxiliary agent include naphthalene compounds, such as 1,4-dihydroxynaphthalene, 1,4-dimethoxynaphthalene, 1,4-diethoxynaphthalene, 4-methoxy-1-naphthol, and 4-ethoxy-1-naphthol; and benzene compounds, such as 1,4-dihydroxybenzene, 1,4-dimethoxybenzene, 1,4-diethoxybenzene, 1-methoxy-4-phenol, and 1-ethoxy-4-phenol. The sensitizing auxiliary agent content of the thermosensitive coloring layer preferably ranges from 10% to 1000% by mass, more preferably 50% to 500% by mass, of the sensitizer content.

The thermosensitive coloring layer may contain a radical polymerization inhibitor. The radical photopolymerization initiator is slightly decomposed into a radical compound during storage of the thermosensitive recording medium. The radical compound may cause polymerization. Thus, the thermosensitive coloring layer can contain a radical polymerization inhibitor to prevent the polymerization.

Examples of the radical polymerization inhibitor include phenolic compounds with a hydroxy group, quinones, such as methoquinone (hydroquinone monomethyl ether), hydroquinone, and 4-methoxy-1-naphthol, hindered amine antioxidants, 1,1-diphenyl-2-picrylhydrazyl free radical, N-oxyl free radical compounds, nitrogen-containing heterocyclic mercapto compounds, thioether antioxidants, hindered phenol antioxidants, ascorbic acids, zinc sulfate, thiocyanates, thiourea derivatives, various saccharides, phosphoric acid antioxidants, nitrites, sulfites, thiosulfates, hydroxylamine derivatives, aromatic amines, phenylenediamines, imines, sulfonamides, urea derivatives, oximes, polycondensates of dicyandiamides and polyalkylene polyamines, sulfur-containing compounds, such as phenothiazines, complexing agents based on tetraazaannulene (TAA), and hindered amines.

Among these, the radical polymerization inhibitor can be a phenol, an N-oxyl free radical compound, a 1,1-diphenyl-2-picrylhydrazyl free radical, phenothiazine, quinone, or a hindered amine. The radical polymerization inhibitor can be an N-oxyl free radical compound. The radical polymerization inhibitor content of the thermosensitive coloring layer can range from 1 to 5,000 ppm of the radical polymerizable compound content.

The thermosensitive coloring layer may contain a pigment with a high degree of whiteness with an average particle size of 10 μm or less. Such a pigment can improve the degree of whiteness of the thermosensitive coloring layer and improve the uniformity of an image. Examples of the pigment include inorganic pigments, such as calcium carbonate, magnesium carbonate, kaolin, clay, talc, calcined clay, silica, diatomaceous earth, synthetic aluminum silicate, zinc oxide, titanium oxide, aluminum hydroxide, barium sulfate, and surface-treated calcium carbonate and silica; and organic pigments, such as urea-formalin resins, styrene-methacrylic acid copolymer resins, and polystyrene resins. The pigment content of the thermosensitive coloring layer can be such that the color density of an image is not decreased. More specifically, the pigment content can be 50% or less by mass of the total solids of the thermosensitive coloring layer.

The thermosensitive coloring layer may contain a binder as a constituent. If necessary, a crosslinking agent, a wax, a metallic soap, a color dye, a color pigment, and a fluorescent dye can be contained. Examples of the binder include poly(vinyl alcohol) and derivatives thereof; starch and derivatives thereof; cellulose derivatives, such as hydroxymethylcellulose, hydroxyethylcellulose, hydroxypropylcellulose, methylcellulose, and ethylcellulose; water-soluble polymeric materials, such as sodium polyacrylate, polyvinylpyrrolidone, acrylamide-acrylate copolymers, acrylamide-acrylate-methacrylate copolymers, styrene-maleic anhydride copolymers, isobutylene-maleic anhydride copolymers, casein, gelatin, and derivatives thereof; emulsions of poly(vinyl acetate), polyurethane, poly(acrylic acid), polyacrylate, vinyl chloride-vinyl acetate copolymers, poly(butyl methacrylate), and ethylene-vinyl acetate copolymers; and latexes of water-insoluble polymers, such as styrene-butadiene copolymers and styrene-butadiene-acrylic copolymers.

A crosslinking agent in the thermosensitive coloring layer can improve the water resistance of the thermosensitive coloring layer. Examples of the crosslinking agent include organic compounds, for example, aldehyde compounds, such as glyoxal, polyamine compounds, such as polyethyleneimine, epoxy compounds, polyamide resins, melamine resins, glyoxylates, dimethylolurea compounds, aziridine compounds, and blocked isocyanate compounds; inorganic compounds, such as ammonium persulfate, iron (III) chloride, magnesium chloride, sodium tetraborate, and potassium tetraborate; and boric acid, boric acid triesters, boron polymers, hydrazide compounds, and glyoxylate salts. The crosslinking agent content of the thermosensitive coloring layer preferably ranges from 1% to 10% by mass of the total solids of the thermosensitive coloring layer.

Examples of the wax include waxes, such as paraffin wax, carnauba wax, microcrystalline wax, polyoletin wax, and polyethylene wax; higher fatty acid amides, such as stearamide and ethylenebisstearamide; and higher fatty acid esters and derivatives thereof. Examples of the metal soap include higher fatty acid polyvalent metal salts, such as zinc stearate, aluminum stearate, calcium stearate, and zinc oleate.

When the thermosensitive recording medium is a two-color thermosensitive recording medium, the thermosensitive coloring layer can contain a color dye or a color pigment with a color tone complementary to a low-temperature color tone. The color tone of the thermosensitive recording medium before and after image formation can be adjusted with such a color dye or a color pigment contained in the thermosensitive coloring layer. Furthermore, if necessary, the thermosensitive coloring layer can contain various auxiliary agents, such as an oil repellent agent, an antifoaming agent, and a viscosity modifier.

The thermosensitive coloring layer can be formed, for example, by applying a coating liquid for a thermosensitive coloring layer containing water as a dispersion medium and containing the components of the thermosensitive coloring layer onto a supporting member to form a coating layer and then drying the coating layer. The amount of the coating liquid to be applied preferably ranges from 2 to 20 g/m², more preferably 2 to 15 g/m², particularly preferably 2 to 10 g/m², on a dry mass basis.

To prepare a particle containing an electron-accepting compound with a radical polymerizable group and a radical photopolymerization initiator, a surfactant can be used. Examples of the surfactant include anionic surfactants, such as sodium alkyl sulfonates, sodium alkylbenzene sulfonates, sodium dialkyl sulfosuccinates, and sodium alkyl carboxylates; nonionic surfactants, such as polyoxyethylene alkyl ethers, polyoxyethylene alkyl esters, polyoxyethylene polyoxypropylene glycol, sorbitan alkyl esters, polyoxyethylene sorbitan alkyl esters, glycerin alkyl esters, and polyoxyethylene hydrogenated castor oil; cationic surfactants, such as alkyl trimethylammonium chlorides, dialkyl dimethylammonium chlorides, and alkylbenzyl dimethylammonium chlorides; and amphoteric surfactants, such as alkyl betaines and alkyl dimethylamine oxides. Furthermore, polymeric surfactants, such as sodium salts of naphthalene sulfonic acid formalin condensates and sodium polyacrylate, can be used.

It is also possible to use a radical polymerizable compound to which an ionic group, such as a sulfonic acid group, a carboxylic acid group, or an amino group, or a hydrophilic nonionic group, such as a polyoxyethylene group or a polyglyceryl group, is bonded to provide surface activity.

To prepare the particle, a dispersing aid can also be used. Examples of the dispersing aid include water-soluble polymers, such as poly(vinyl alcohol) and modified products thereof, polyacrylamide and derivatives thereof, ethylene/vinyl acetate copolymers, styrene/maleic anhydride copolymers, ethylene/maleic anhydride copolymers, isobutylene/maleic anhydride copolymers, polyvinylpyrrolidone, ethylene/acrylic acid copolymers, vinyl acetate/acrylic acid copolymers, carboxymethylcellulose, methylcellulose, casein, gelatin, starch derivatives, gum arabic, and sodium alginate.

The amount of the surfactant or the dispersing aid to be added preferably ranges from 0.1% to 10% by mass, more preferably 0.5% to 5% by mass, of the mass of each of the particle.

### Intermediate Layer

When the thermosensitive coloring layer includes an electron-donating dye precursor layer (leuco layer) and an electron-accepting compound layer with a radical polymerizable group (developer layer), an intermediate layer can be provided between these layers. The intermediate layer may be formed of a water-soluble polymeric material or a water-insoluble polymer used in a known thermosensitive recording medium. Specific examples of the material constituting the intermediate layer include the materials for the binder constituting the thermosensitive coloring layer. Furthermore, the intermediate layer may contain, as auxiliary agents, particles with high porosity, such as silica and calcined kaolin, or an organic compound, such as a plastic pigment, hollow particles, foam, or a polyethylene wax with a glass transition point or a melting point.

The intermediate layer can be formed, for example, by applying a coating liquid for an intermediate layer containing water as a dispersion medium and containing the components of the intermediate layer to form a coating layer and then drying the coating layer. The amount of the coating liquid to be applied preferably ranges from 1 to 40 g/m², more preferably 2 to 10 g/m², on a dry mass basis.

Furthermore, an intermediate layer may also be provided between two thermosensitive coloring layers. The intermediate layer between thermosensitive coloring layers can contain an ultraviolet absorber. The ultraviolet absorber in the intermediate layer can control the ultraviolet transmittance of the intermediate layer to a desired value.

The ultraviolet absorber may be a benzotriazole ultraviolet absorber, a triazine ultraviolet absorber, a benzophenone ultraviolet absorber, a cyanoacrylate ultraviolet absorber, a salicylic acid ultraviolet absorber, or titanium oxide.

### Protective Layer

A protective layer can be provided on the thermosensitive coloring layer. The protective layer may be a protective layer used in a known thermosensitive recording medium. For example, the protective layer can contain a water-soluble polymeric material and particles. The water-soluble polymeric material and particles may be a material that can be contained in the thermosensitive coloring layer. Furthermore, a crosslinking agent can be added to provide the protective layer with water resistance.

Microcapsules containing an ultraviolet absorber or solid dispersed fine particles of an ultraviolet absorber in the protective layer can greatly improve light resistance. In particular, microcapsules with a wall film formed of a polyurethane-polyurea resin or an amino-aldehyde resin have high heat resistance and good accompanying effects, such as prevention of sticking to a thermal head. Furthermore, microcapsules with a wall film formed of a polyurethane-polyurea resin or an amino-aldehyde resin have a lower refractive index than microcapsules with a wall film formed of another resin. Furthermore, such microcapsules are spherical, and even the addition of a large number of such microcapsules to the protective layer rarely causes a decrease in density due to diffused reflection of light.

Furthermore, particles in the protective layer can prevent adhesion and sticking of dirt to a thermal head. The particles can preferably absorb at least 50 mL/100 g of oil. The particle content of the protective layer can be such that the color density is not decreased and, more specifically, is preferably 60% or less by mass of the total solids of the protective layer.

The protective layer can be formed, for example, by applying a coating liquid for a protective layer containing water as a dispersion medium and containing the components of the protective layer onto the thermosensitive coloring layer to form a coating layer and then drying the coating layer. The amount of the coating liquid to be applied preferably ranges from 0.1 to 15 g/m², more preferably 0.5 to 8 g/m², on a dry mass basis.

### Resin Layer

A resin layer formed of a resin cured by an electron beam or ultraviolet radiation can be provided on each of the thermosensitive coloring layer, the intermediate layer, and the protective layer. The resin to be cured by an electron beam may be a resin described in Japanese Patent Laid-Open No. 58-177392. Auxiliary agents, such as a non-electron-beam-curable resin, particles, an antifoaming agent, a leveling agent, a lubricant, a surfactant, and a plasticizer, may be appropriately added to the resin constituting the resin layer. In particular, the addition of particles of calcium carbonate, aluminum hydroxide, or the like or a lubricant, such as a wax or silicon, can prevent sticking to a thermal head.

### Other Layers

A thermosensitive recording medium may be processed to have a higher function and a higher added value. For example, an adhesive, a remoistening adhesive agent, or a delayed-tack adhesive may be applied to the back surface to produce adhesive paper, remoistening adhesive paper, or delayed-tack paper. Furthermore, a function of thermal transfer paper, ink jet recording paper, carbonless paper, electrostatic recording paper, or xerography paper may be provided on the back surface to produce double-sided recording paper. Furthermore, a thermosensitive coloring layer may also be provided on the back surface to produce a double-sided thermosensitive recording medium. Furthermore, a back layer may be provided on the back surface of the thermosensitive recording medium to prevent permeation of oil or a plasticizer from the back surface, to control curling, or to prevent charging.

### Layer Structure of Thermosensitive Recording Medium

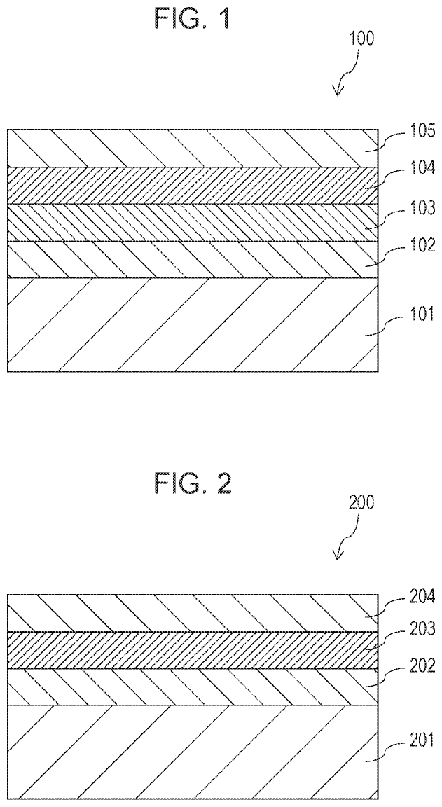

FIG. 1 is a cross-sectional view of a thermosensitive recording medium according to an embodiment of the present disclosure. A thermosensitive recording medium 100 in FIG. 1 includes a sheet-like supporting member 101. On one surface of the supporting member 101, an electron-donating dye precursor layer 102, an intermediate layer 103, an electron-accepting compound layer 104 with a radical polymerizable group, and a protective layer 105 are laminated in this order. In a thermosensitive recording medium according to an embodiment of the present disclosure, the order of the electron-donating dye precursor layer 102 and the electron-accepting compound layer 104 with a radical polymerizable group may be reversed, and the protective layer 105 as illustrated in FIG. 1 may be omitted.

FIG. 2 is a cross-sectional view of a thermosensitive recording medium according to another embodiment of the present disclosure. A thermosensitive recording medium 200 in FIG. 2 includes a sheet-like supporting member 201 and includes an electron-donating dye precursor layer 202, an electron-accepting compound layer 203 with a radical polymerizable group, and a protective layer 204 laminated in this order on one surface of the supporting member 201. In a thermosensitive recording medium according to an embodiment of the present disclosure, the order of the electron-donating dye precursor layer 202 and the electron-accepting compound layer 203 with a radical polymerizable group may be reversed, and the protective layer 204 as illustrated in FIG. 2 may be omitted.

The supporting members 101 and 201 may be formed of a material on which a coating film can be formed using a coating liquid for a thermosensitive coloring layer (a thermosensitive coloring composition). A material constituting the supporting members 101 and 201 may be paper, synthetic paper, or a plastic. The plastic may be poly(ethylene terephthalate) (PET) or oriented polypropylene (OPP). If necessary, the surfaces of the supporting members 101 and 201 can be subjected to corona discharge treatment, sandblast treatment, primer treatment (lamination of an undercoat layer), or the like. These treatments can improve the wettability of the surfaces of the supporting members 101 and 201, roughen the surfaces, or improve the adhesiveness of the surfaces, and can improve the formability of a coating film of a thermosensitive coloring composition.

A coating film can be formed by applying or printing a thermosensitive coloring composition on the supporting members 101 and 201. The thermosensitive coloring composition may be applied or printed with a blade coater, a rod coater, a reverse roll coater, a die coater, an offset press, a gravure printing machine, a flexo printing machine, a relief printing machine, or a silkscreen printing machine. The intermediate layer (including a protective intermediate layer) and the protective layer can be formed using an intermediate layer composition and an overcoat composition, which are prepared by a method for preparing the thermosensitive coloring composition. The intermediate layer composition and the overcoat composition can be applied to a predetermined portion to form a coating film. The coating film thus formed can be dried to form each layer and thereby complete an intended thermosensitive recording medium. Each coating film may be formed by application and drying, or the same coating liquid may be applied and dried two times or more. Furthermore, simultaneous multilayer coating in which two or more coating liquids are simultaneously applied may be performed. A smoothing process can be performed by a known method, such as supercalendering or soft calendaring, after each layer is formed, after all layers are formed, or the like. The surface smoothing process can improve recording sensitivity and the uniformity of an image to be formed.

### <Image-Forming Method>

Next, an image-forming method according to the present disclosure is described. An image-forming method according to the present disclosure includes the step of heating the thermosensitive recording medium to form an image (an image forming step). The thermosensitive recording medium may be heated by any method, for example, a known heating method. In particular, from the perspective of downsizing an image-forming apparatus, the thermosensitive recording medium can be heated with a thermal head. More specifically, the thermosensitive recording medium can be heated by applying a heat pulse to the heated recording medium using a thermal head.

The temperature of the heat pulse applied to the thermosensitive recording medium in the image forming step may range from 80° C. to 120° C. While the thermosensitive recording medium is in contact with the thermal head, the heat pulse can be applied to the thermosensitive coloring layer of the thermosensitive recording medium to form a desired image. More specifically, heating by the heat pulse dissolves a radical polymerizable compound in the thermosensitive coloring layer. The dissolution of the radical polymerizable compound can bring the electron-donating dye precursor into contact with the electron-accepting compound and enables the thermosensitive coloring layer to develop color and form an image.

The image-forming method can further include the step of irradiating the thermosensitive recording medium on which an image is formed with ultraviolet radiation to fix the thermosensitive coloring layer (a fixing step).

In the fixing step, the thermosensitive recording medium on which an image is formed is irradiated with ultraviolet radiation. The ultraviolet radiation may have a wavelength at which a radical polymerization initiator in the thermosensitive coloring layer can react, for example, a wavelength in the range of 365 to 425 nm. The ultraviolet radiation can cause a polymerization reaction of the radical polymerizable compound and fix the thermosensitive coloring layer. Once the thermosensitive coloring layer is fixed, subsequently applied thermal energy corresponding to the coloring start temperature does not cause coloring of the thermosensitive coloring layer, and the formed image can maintain its color developability for extended periods. The term the “wavelength” of ultraviolet radiation, as used herein, refers to the peak wavelength of the ultraviolet radiation. The phrase “fix a thermosensitive coloring layer”, as used herein, refers to fixing the coloring state of the thermosensitive coloring layer.

The present disclosure can provide a thermosensitive recording medium that can prevent coloring due to heating after ultraviolet radiation even when the amount of ultraviolet radiation is small. The present disclosure can also provide an image-forming method using the thermosensitive recording medium.

### EXAMPLES

Although the present disclosure is further described below in the exemplary embodiments and comparative examples, the present disclosure is not limited to these exemplary embodiments within the gist of the present disclosure. Unless otherwise specified, “part(s)” and “%” with respect to the amount of component are based on mass.

### <Production of Thermosensitive Recording Medium (1)>

### Exemplary Embodiment 1

[Production of Electron-Accepting Compound with Radical Polymerizable Group]

The compound (D-39), which is an exemplary compound of the electron-accepting compound with a radical polymerizable group, was produced by the following method.

First, 55 parts of TGSH(H) (manufactured by Nippon Kayaku Co., Ltd.) was dissolved in 202 parts of ethyl acetate, and 43 parts of Karenz BEI (manufactured by Showa Denko K.K.) was added. The mixture was stirred at 55° C. for 24 hours to prepare the compound (D-39).

[Analysis of Electron-Accepting Compound with Radical Polymerizable Group]

To confirm that the prepared compound had the structure of the compound (D-39), the following analyses (1) to (4) were performed after appropriate pretreatment.

(1) ¹H-NMR measurement: 600 MHz, CDCl₃, at room temperature (20° C.)

δ [ppm]=7.2 (a), 5.1 (b)

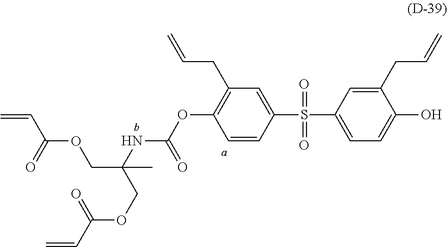 [SMILES: C=CCc1cc(S(=O)(=O)c2ccc(OC(=O)NC(C)(COC(=O)C=C)COC(=O)C=C)c(CC=C)c2)ccc1O]

(2) ¹³C-NMR measurement: 600 MHz, CDCl₃, at room temperature (20° C.)

δ [ppm]=152 (c)

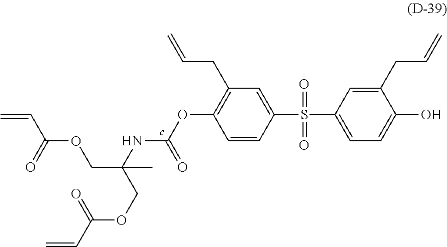 [SMILES: C=CCc1cc(S(=O)(=O)c2ccc(OC(=O)NC(C)(COC(=O)C=C)COC(=O)C=C)c(CC=C)c2)ccc1O]

The analyses (1) and (2) show the formation of —NHCO— (a urethane bond).

(3) LC-MS measurement:

Liquid chromatography (LC) measurement conditions: Unison UK-Phenyl (particle size: 3 μm×150 mm) column, 40° C., water/methanol=40/60

Mass spectrometry (MS) measurement conditions: ESI, Positive, 380° C.

The analysis results of (3) show that the molecular weight was the same as that of the compound (D-39).

(4) FT-IR measurement: ATR method, germanium, at room temperature (20° C.)

The analysis results of (4) show that the reaction decreased the —NCO (isocyanate group) peak of Karenz BEI (manufactured by Showa Denko K.K.).

These analyses show that the compound had the structure of the compound (D-39).

### [Preparation of Raw Material Composition]

Liquids [A] to [D] were prepared in the following manner.

Liquid [A]: A composition containing an electron-accepting compound with a radical polymerizable group
Compound (D-39) 30 parts
Radical photopolymerization initiator (Irgacure OXE01 manufactured by BASF Japan Ltd.) 8 parts
Ethyl acetate 62 parts

These materials were mixed and dissolved to prepare the liquid [A].

Liquid [B]: A dispersion liquid of particles containing an electron-donating dye precursor
Electron-donating dye precursor (BLUE 220, manufactured by Fukui Yamada Chemical Co., Ltd.) 3 parts
Dispersant (Pelex NBL, manufactured by Kao Corporation) 0.3 parts
Water 96.7 parts

These materials were mixed and were ground and dispersed in a bead mill to prepare the liquid [B]. The particle size (D50) of the dispersion liquid of particles containing an electron-donating dye precursor was approximately 700 nm as measured with a particle size distribution measuring apparatus (Nanotrac, manufactured by Microtrac).

Liquid [C]: A coating liquid for an intermediate layer
Poly(vinyl alcohol) (Kuraray Poval 5-88 manufactured by Kuraray Co., Ltd.) 10 parts
Water 90 parts

These materials were mixed and dissolved to prepare the liquid [C].

Liquid [D]: A kaolin dispersion liquid
Kaolin (HYDRAGLOSS 90, manufactured by KaMin, LLC) 59.5 parts
Dispersant (Aron T-50, manufactured by Toagosei Co., Ltd., solid content: 40%) 0.5 parts
Water 40 parts

These materials were dispersed with a Cowles disperser for one hour to prepare the liquid [D].

### [Formation of Thermosensitive Coloring Layer]

The liquid [B] was applied to a synthetic paper (YUPO manufactured by Yupo Corporation) 130 μm in thickness with a printability testing machine and was dried with a dryer. The coating amount of the liquid [B] after drying was 40.0 g/m², and the coating amount of BLUE 220 was 1.2 g/m². The liquid [C] was then applied with the printability testing machine and was dried with the dryer. The coating amount of the liquid [C] after drying was 0.2 g/m². Subsequently, the liquid [A] was applied with the printability testing machine and was dried with the dryer to form a thermosensitive coloring layer. The coating amount of the liquid [A] after drying was 60.0 g/m², and the amount of the compound (D-39) was 18.0 g/m².

### [Formation of Protective Layer]

210 parts of a 10% aqueous solution of acetoacetyl-modified poly(vinyl alcohol) A, 80 parts of a 20% aqueous solution of acetoacetyl-modified poly(vinyl alcohol) B, 100 parts of the liquid [D], 5.6 parts of an aqueous dispersion of zinc stearate, and 2.5 parts of a polyethylene wax emulsion were prepared. These components were mixed and stirred to prepare a coating liquid for a protective layer. The acetoacetyl-modified poly(vinyl alcohol) A was “Gohsefimer Z-200” (trade name, degree of saponification: 99.4% by mole, average degree of polymerization: 1,000, degree of modification: 5% by mole, manufactured by The Nippon Synthetic Chemical Industry Co., Ltd.). The acetoacetyl-modified poly(vinyl alcohol) B was “Gohsefimer Z-100” (trade name, degree of saponification: 99.4% by mole, average degree of polymerization: 500, degree of modification: 5% by mole, manufactured by The Nippon Synthetic Chemical Industry Co., Ltd.). The aqueous dispersion of zinc stearate was “Hidorin Z-8-36” (trade name, manufactured by Chukyo Yushi Co., Ltd., solid content: 36%). The polyethylene wax emulsion was “Chemipearl W-400” (trade name, solid content: 40%, manufactured by Mitsui Chemicals, Inc.).

The coating liquid for a protective layer was applied to the thermosensitive coloring layer such that the coating amount after drying was 1.5 g/m² and was dried to form a protective layer. The surface of the protective layer was smoothed by supercalendering to prepare a thermosensitive recording medium.

### Exemplary Embodiments 2 to 16

The electron-donating dye precursor, the radical photopolymerization initiator, and the electron-accepting compound with a radical polymerizable group used in Exemplary Embodiment 1 were changed as shown in Table 1 to prepare thermosensitive recording media of Exemplary Embodiments 2 to 16.

### <Production of Thermosensitive Recording Medium (2)>

### Exemplary Embodiment 17

### [Preparation of Raw Material Composition]

Liquids [E] to [I] were prepared in the following manner.

Liquid [E]: A composition containing an electron-accepting compound with a radical polymerizable group
Compound (D-39) 30 parts
Radical photopolymerization initiator (Irgacure OXE01 manufactured by BASF Japan Ltd.) 8 parts
Ethyl acetate 62 parts

These materials were mixed and dissolved to prepare the liquid [E].

Liquid [F]: A dispersion liquid of particles containing an electron-donating dye precursor
Electron-donating dye precursor (BLUE 220, manufactured by Fukui Yamada Chemical Co., Ltd.) 3 parts
Dispersant (Pelex NBL, manufactured by Kao Corporation) 0.3 parts
Water 96.7 parts

These materials were mixed and were ground and dispersed in a bead mill to prepare the liquid [F]. The particle size (D50) of the dispersion liquid of particles containing an electron-donating dye precursor was approximately 700 nm as measured with a particle size distribution measuring apparatus (Nanotrac, manufactured by Microtrac).

Liquid [G]: A liquid containing a dispersant
Dispersant (Pelex NBL, manufactured by Kao Corporation) 10 parts
Water 100 parts

These materials were mixed and dissolved to prepare the liquid [G].

Liquid [H]: A dispersion liquid of particles containing an electron-accepting compound with a radical polymerizable group

50 parts of the liquid [E] and 50 parts of the liquid [G] were mixed and emulsified with an ultrasonic homogenizer (UH-600S, manufactured by SMT Co., Ltd.). Then, ethyl acetate was removed under reduced pressure with a rotary evaporator to prepare a dispersion liquid [H] of particles containing an electron-accepting compound with a radical polymerizable group. The particle size (D50) of the particles in the dispersion liquid of particles containing an electron-accepting compound with a radical polymerizable group was 160 nm as measured with a particle size distribution measuring apparatus (Nanotrack, manufactured by Microtrac).

Liquid [I]: A kaolin dispersion liquid
Kaolin (HYDRAGLOSS 90, manufactured by KaMin, LLC) 59.5 parts
Dispersant (Aron T-50, manufactured by Toagosci Co., Ltd., solid content: 40%) 0.5 parts
Water 40 parts

These materials were dispersed with a Cowles disperser for one hour to prepare the liquid [1].

### [Formation of Thermosensitive Coloring Layer]

The liquid [F] was applied to a synthetic paper (YUPO manufactured by Yupo Corporation) 130 μm in thickness with the printability testing machine and was dried with the dryer. The coating amount of the liquid [F] after drying was 40.0 g/m², and the coating amount of BLUE 220 was 1.2 g/m². Subsequently, the liquid [H] was applied with the printability testing machine and was dried with the dryer to form a thermosensitive coloring layer. The coating amount of the liquid [H] after drying was 60.0 g/m², and the amount of the compound (D-39) was 18.0 g/m².

### [Formation of Protective Layer]

210 parts of a 10% aqueous solution of acetoacetyl-modified poly(vinyl alcohol) A, 80 parts of a 20% aqueous solution of acetoacetyl-modified poly(vinyl alcohol) B, 100 parts of the liquid [1], 5.6 parts of an aqueous dispersion of zinc stearate, and 2.5 parts of a polyethylene wax emulsion were prepared. These components were mixed and stirred to prepare a coating liquid for a protective layer. The acetoacetyl-modified poly(vinyl alcohol) A was “Gohsefimer Z-200” (trade name, degree of saponification: 99.4% by mole, average degree of polymerization: 1,000, degree of modification: 5% by mole, manufactured by The Nippon Synthetic Chemical Industry Co., Ltd.). The acetoacetyl-modified poly(vinyl alcohol) B was “Gohsefimer Z-100” (trade name, degree of saponification: 99.4% by mole, average degree of polymerization: 500, degree of modification: 5% by mole, manufactured by The Nippon Synthetic Chemical Industry Co., Ltd.). The aqueous dispersion of zinc stearate was “Hidorin Z-8-36” (trade name, manufactured by Chukyo Yushi Co., Ltd., solid content: 36%). The polyethylene wax emulsion was “Chemipearl W-400” (trade name, solid content: 40%, manufactured by Mitsui Chemicals, Inc.). The coating liquid for a protective layer was applied to the thermosensitive coloring layer such that the coating amount after drying was 1.5 g/m² and was dried to form a protective layer. The surface of the protective layer was smoothed by supercalendering to prepare a thermosensitive recording medium.

The coating liquid for a protective layer was applied to the thermosensitive coloring layer such that the coating amount after drying was 1.5 g/m² and was dried to form a protective layer. The surface of the protective layer was smoothed by supercalendering to prepare a thermosensitive recording medium.

### Comparative Examples 1 to 4

The electron-donating dye precursor, the radical photopolymerization initiator, and the electron-accepting compound with a radical polymerizable group used in Exemplary Embodiment 1 were changed as shown in Table 1 to prepare thermosensitive recording media of Comparative Examples 1 to 4.

### <Production of Thermosensitive Recording Medium (3)>

### Comparative Example 5

### [Preparation of Raw Material Composition]

Liquids [J] to [M] were prepared in the following manner.

Liquid [J]: A composition containing an electron-donating dye precursor
Electron-donating dye precursor (BLUE 220, manufactured by Fukui Yamada Chemical Co., Ltd.) 3 parts
Radical polymerizable compound (8KX-078, manufactured by Taisei Fine Chemical Co., Ltd.) 30 parts
Radical photopolymerization initiator (Omnirad TPO, manufactured by 1GM Resins) 9 parts
Ethyl acetate 58 parts

These materials were mixed and dissolved to prepare the liquid [J].

Liquid [K]: A dispersion liquid of particles containing an electron-accepting compound
Electron-accepting compound (TGSH(H), manufactured by Nippon Kayaku Co., Ltd.) 40 parts
Dispersant (Pelex NBL, manufactured by Kao Corporation) 4 parts
Water 56 parts

These materials were mixed and were ground and dispersed in a bead mill to prepare the liquid [K]. The particle size (D50) of the dispersion liquid of particles containing an electron-accepting compound was approximately 700 nm as measured with a particle size distribution measuring apparatus (Nanotrac, manufactured by Microtrac).

Liquid [L]: A coating liquid for an intermediate layer
Poly(vinyl alcohol) (Kuraray Poval 5-88 manufactured by Kuraray Co., Ltd.) 10 parts
Water 90 parts

These materials were mixed and dissolved to prepare the liquid [L].

Liquid [M]: A kaolin dispersion liquid
Kaolin (HYDRAGLOSS 90, manufactured by KaMin, LLC) 59.5 parts
Dispersant (Aron T-50, manufactured by Toagosei Co., Ltd., solid content: 40%) 0.5 parts
Water 40 parts

These materials were dispersed with a Cowles disperser for one hour to prepare the liquid [M].

### [Formation of Thermosensitive Coloring Layer]

The liquid [J] was applied to a synthetic paper (YUPO manufactured by Yupo Corporation) 130 μm in thickness with the printability testing machine and was dried with the dryer to evaporate ethyl acetate. The coating amount of the liquid [J] after drying was 40.0 g/m², and the coating amount of BLUE 220 was 1.20 g/m². The liquid [L] was then applied with the printability testing machine and was dried with the dryer. The coating amount of the liquid [L] after drying was 0.2 g/m². The liquid [K] was then applied with the printability testing machine and was dried with the dryer. The coating amount of the liquid [K] after drying was 30.0 g/m², and the amount of TGSH(H) was 12.0 g/m².

### [Formation of Protective Layer]

210 parts of a 10% aqueous solution of acetoacetyl-modified poly(vinyl alcohol) A, 80 parts of a 20% aqueous solution of acetoacetyl-modified poly(vinyl alcohol) B, 100 parts of the liquid [M], 5.6 parts of an aqueous dispersion of zinc stearate, and 2.5 parts of a polyethylene wax emulsion were prepared. These components were mixed and stirred to prepare a coating liquid for a protective layer. The acetoacetyl-modified poly(vinyl alcohol) A was “Gohsefimer Z-200” (trade name, degree of saponification: 99.4% by mole, average degree of polymerization: 1,000, degree of modification: 5% by mole, manufactured by The Nippon Synthetic Chemical Industry Co., Ltd.). The acetoacetyl-modified poly(vinyl alcohol) B was “Gohsefimer Z-100” (trade name, degree of saponification: 99.4% by mole, average degree of polymerization: 500, degree of modification: 5% by mole, manufactured by The Nippon Synthetic Chemical Industry Co., Ltd.). The aqueous dispersion of zinc stearate was “Hidorin Z-8-36” (trade name, manufactured by Chukyo Yushi Co., Ltd., solid content: 36%). The polyethylene wax emulsion was “Chemipearl W-400” (trade name, solid content: 40%, manufactured by Mitsui Chemicals, Inc.).

The coating liquid for a protective layer was applied to the thermosensitive coloring layer such that the coating amount after drying was 1.5 g/m² and was dried to form a protective layer. The surface of the protective layer was smoothed by supercalendering to prepare a thermosensitive recording medium.

### <Formation and Evaluation of Image>

### (Color Developability)

A thermal head (KPE type, manufactured by Kyocera Corporation) was used to heat a 2 cm×2 cm region on the surfaces of the thermosensitive recording media prepared in Exemplary Embodiments 1 to 17 and Comparative Examples 1 to 5 to form an image. The applied electric power and the pulse width of the thermal head were set such that the recording energy per unit area was 150 mJ/mm². The optical density of the formed image was measured with a reflection densitometer (trade name “Xrite 530”, manufactured by Sakata Inx Eng. Co., Ltd.). Table 2 shows the measurement results.

As shown in Table 2, a comparison of the results of Exemplary Embodiments 1 to 12 and 17 with the results of Exemplary Embodiments 13 to 16 shows that the optical density is higher when the amount of the electron-accepting compound with a radical polymerizable group is 1500% or more by mass of the amount of the electron-donating dye precursor than when the amount is less than 1500% by mass.

### UV Fixability

The thermosensitive recording media prepared in Exemplary Embodiments 1 to 17 and Comparative Examples 1 to 5 were irradiated once with ultraviolet radiation at a conveyor speed of 100 or 10 m/min using three ultraviolet radiation apparatuses (ME 12-L61, manufactured by Eye Graphics Co., Ltd.) equipped with a metal halide lamp (120 W/cm). The integrated light quantity separately measured under the same conditions with an ultraviolet integrated light meter (C9536-01, manufactured by Hamamatsu Photonics K.K.) was 100 mJ/cm² and 1,000 mJ/cm², respectively.

Subsequently, the thermal head (KPE type, manufactured by Kyocera Corporation) was used to form a 2 cm×2 cm image on the thermosensitive recording media prepared in Exemplary Embodiments 1 to 17 and Comparative Examples 1 to 5 irradiated with ultraviolet radiation. The applied electric power and the pulse width were set such that the recording energy per unit area was 150 mJ/mm². The optical density of the formed image was measured with a reflection densitometer (trade name “Xrite 530”, manufactured by Sakata Inx Eng. Co., Ltd.). Table 2 shows a difference from the optical density of the synthetic paper (YUPO manufactured by Yupo) as “Δoptical density”.

As shown in Table 2, sufficient fixing was proved in Exemplary Embodiments 1 to 17 by the absolute values of Δoptical densities of the images after irradiation at the integrated light quantity of 100 or 1,000 mJ/cm². More specifically, ultraviolet radiation even at a low integrated light quantity of 100 mJ/cm² could prevent coloring due to heating after ultraviolet radiation.

By contrast, in Comparative Examples 1 to 4, although phenolic compounds (D-49) and (D-50) are used as electron-accepting compounds with a radical polymerizable group, the Δoptical density at an integrated light quantity of 1,000 mJ/cm² is 0.17 or more, which shows poorer coloring than Exemplary Embodiments 1 to 17. Furthermore, the Δoptical density at an integrated light quantity of 100 mJ/cm² is 0.45 or more, which shows much poorer coloring than Exemplary Embodiments 1 to 17. In other words, coloring due to heating after ultraviolet radiation was much poorer at a lower integrated light quantity of 100 mJ/cm².

Furthermore, in Comparative Example 5 although an electron-accepting compound with no radical polymerizable group and a radical polymerizable compound are used instead of the electron-accepting compound with a radical polymerizable group, the Δoptical density is 0.18 at an integrated light quantity of 1,000 mJ/cm² and 0.20 at an integrated light quantity of 100 mJ/cm², which are slightly poorer coloring than Exemplary Embodiments 1 to 17.

TABLE 1
Configuration of thermosensitive recording medium

| | | | | | Electron- | |
|---|---|---|---|---|---|---|
| | | | | | accepting | |
| | Electron-accepting | | | | compound | |
| | compound with a radical | | Electron- | | with no | |
| | polymerizable group | | donating | Radical | radical | Radical |
| | Compound | Amount | dye | photopolymerization | polymerizable | polymerizable |
| | No. | [mass %] | precursor | initiator | group | compound |
| Exemplary embodiment 1 | (D-39) | 1500 | C | lrgacure OXE01 | — | — |
| Exemplary embodiment 2 | (D-39) | 1500 | M-1 | lrgacure OXE01 | — | — |
| Exemplary embodiment 3 | (D-39) | 1500 | M-2 | lrgacure OXE01 | — | — |
| Exemplary embodiment 4 | (D-39) | 1500 | Y | lrgacure OXE01 | — | — |
| Exemplary embodiment 5 | (D-40) | 1500 | C | lrgacure OXE01 | — | — |
| Exemplary embodiment 6 | (D-41) | 1500 | C | lrgacure OXE01 | — | — |
| Exemplary embodiment 7 | (D-42) | 1500 | C | lrgacure OXE01 | — | — |
| Exemplary embodiment 8 | (D-43) | 1500 | C | lrgacure OXE01 | — | — |
| Exemplary embodiment 9 | (D-44) | 1500 | C | lrgacure OXE01 | — | — |
| Exemplary embodiment 10 | (D-39) | 2000 | C | lrgacure OXE01 | — | — |
| Exemplary embodiment 11 | (D-39) | 1500 | C | Omnirad TPO | — | — |
| Exemplary embodiment 12 | (D-39) | 1500 | C | Omnirad 819 | — | — |
| Exemplary embodiment 13 | (D-39) | 800 | C | Omnirad TPO | — | — |
| Exemplary embodiment 14 | (D-39) | 1000 | C | Omnirad TPO | — | — |
| Exemplary embodiment 15 | (D-1) | 1000 | C | Ornnirad TPO | — | — |
| Exemplary embodiment 16 | (D-2) | 1000 | C | Omnirad TPO | — | — |
| Exemplary embodiment 17 | (D-39) | 1500 | C | lrgacure OXE01 | — | — |
| Comparative example 1 | (D-49) | 1500 | C | Omnirad TPO | — | — |
| Comparative example 2 | (D-49) | 2000 | C | Omnirad TPO | — | — |
| Comparative example 3 | (D-50) | 1500 | C | Omnirad TPO | — | — |
| Comparative example 4 | (D-50) | 2000 | C | Omnirad TPO | — | — |
| Comparative example 5 | — | — | C | Omnirad TPO | TGSH(H) | 8KX-078 |

TABLE 2
Evaluation results

| | UV fixability (Δoptical density) | | |
|---|---|---|---|
| | | Integrated | |
| | Color | light | |
| | developability | quantity | Integrated |
| | 100mJ/ | 1000mJ/ | light |
| (Optical density) | cm² | cm² | quantity |
| Exemplary embodiment 1 | 1.80 | 0.01 | 0.01 |
| Exemplary embodiment 2 | 1.80 | 0.02 | 0.02 |
| Exemplary embodiment 3 | 1.80 | 0.02 | 0.02 |
| Exemplary embodiment 4 | 1,80 | 0.01 | 0.01 |
| Exemplary embodiment 5 | 1.80 | 0.02 | 0.02 |
| Exemplary embodiment 6 | 1,80 | 0.02 | 0.02 |
| Exemplary embodiment 7 | 1.80 | 0.01 | 0.01 |
| Exemplary embodiment 8 | 1.80 | 0,02 | 0.02 |
| Exemplary embodiment 9 | 1.80 | 0.01 | 0.01 |
| Exemplary embodiment 10 | 1.90 | 0.02 | 0.02 |
| Exemplary embodiment 11 | 1.80 | 0.10 | 0.08 |
| Exemplary embodiment 12 | 1.80 | 0.10 | 0.07 |
| Exemplary embodiment 13 | 1,15 | 0.10 | 0.08 |
| Exemplary embodiment 14 | 1.20 | 0.10 | 0.07 |
| Exemplary embodiment 15 | 1.20 | 0.15 | 0.12 |
| Exemplary embodiment 16 | 1.20 | 0.15 | 0.12 |
| Exemplary embodiment 17 | 1.80 | 0.01 | 0.01 |
| Comparative example 1 | 1.80 | 0.55 | 0.25 |
| Comparative example 2 | 1.90 | 0.48 | 0.18 |
| Comparative example 3 | 1.80 | 0.50 | 0.24 |
| Comparative example 4 | 1.90 | 0.45 | 0.17 |
| Comparative example 5 | 1.87 | 0.20 | 0.18 |

The electron-accepting compounds with a radical polymerizable group (D-39) to (D-44) in Table 1 are the same as the exemplary compounds (D-39) to (D-44) of the electron-accepting compound with a radical polymerizable group described above.

Table 3 shows the structures of electron-accepting compounds with a radical polymerizable group other than (D-39) to (D-44) shown in Table 1.

TABLE 3
Type of electron-accepting compound with radical
polymerizable group used in comparative examples

| | Structure |
|---|---|
| (D-49) | 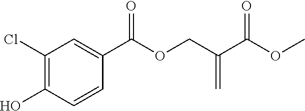 [SMILES: C=C(COC(=O)c1ccc(O)c(Cl)c1)C(=O)OC] |
| (D-50) | 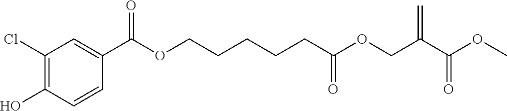 [SMILES: C=C(COC(=O)CCCCCOC(=O)c1ccc(O)c(Cl)c1)C(=O)OC] |

Table 4 shows the details of the electron-donating dye precursors shown in Table 1.

TABLE 4
Type of electron-donating dye precursor

| | Product name | Manufacturer |
|---|---|---|
| C | BLUE220 | Fukui Yamada Chemical Co., Ltd, |
| M-1 | RED500 | Fukui Yamada Chemical Co., Ltd, |
| M-2 | RED40 | Fukui Yamada Chemical Co., Ltd, |
| Y | YELLOW435 | Fukui Yamada Chemical Co., Ltd, |

Table 5 shows the details of the radical photopolymerization initiators shown in Table 1.

TABLE 5
Type of radical photopolymerization initiator

| Product name | Manufacturer | Compound name |
|---|---|---|
| Irgacure OXE01 | BASF Japan Ltd. | Ketoxime compound |
| Omnirad TPO | IGM Resins B.V. | Acylphosphine oxide |
| | | compound |
| Omnirad 819 | IGM Resins B.V. | Acylphosphine oxide |
| | | compound |

Table 6 shows the details of the electron-accepting compound with no radical polymerizable group shown in Table 1.

TABLE 6
Type of electron-accepting compound with no radical
polymerizable group used in comparative example

| Product name | Manufacturer |
|---|---|
| TGSH(H) | Nippon Kayaku Co., Ltd. |

Table 7 shows the details of the radical polymerizable compound shown in Table 1.

TABLE 7
Type of radical polymerizable compound used in
comparative example

| Product name | Manufacturer |
|---|---|
| 8KX-078 | Taisei Fine Chemical Co., Ltd. |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-197404 filed Nov. 27, 2020 and No. 2021-171010 filed Oct. 19, 2021, which are hereby incorporated by reference herein in their entirety.

What is claimed is:

1. A thermosensitive recording medium comprising: a thermosensitive coloring layer containing an electron-donating dye precursor, a radical photopolymerization initiator, and an electron-accepting compound with a radical polymerizable group,
wherein the electron-accepting compound with a radical polymerizable group includes a compound A represented by the formula (1): 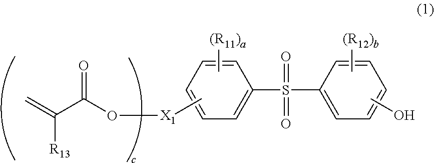
wherein R₁₁ and R₁₂ independently denote a hydrocarbon group having 1 to 8 carbon atoms,
R₁₃ denotes a hydrogen atom or a methyl group,
X₁ denotes a single bond or a hydrocarbon group having 1 to 50 carbon atoms,
a methylene group in the group denoted by Xᵢ is optionally substituted with a heterocycle, —NHCOO—, —NHCO—, —O—, —CO—, —COO—, or —NR₁₄—,
R₁₄ denotes a hydrogen atom or a hydrocarbon group having 1 to 8 carbon atoms,
a and b independently denote an integer in the range of 0 to 4, and
c denotes an integer in the range of 1 to 10.

2. The thermosensitive recording medium according to claim 1, wherein the compound A is represented by the formula (2): 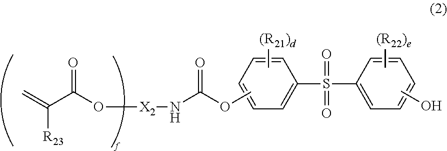
wherein R₂₁ and R₂₂ independently denote a hydrocarbon group having 1 to 8 carbon atoms,
R₂₃ denotes a hydrogen atom or a methyl group,
X₂ denotes a hydrocarbon group having 1 to 49 carbon atoms,
a methylene group in the group denoted by X₂ is optionally substituted with —NHCOO—, —NHCO—, —O—, —CO—, —COO—, or —NR₂₄—,
R₂₄ denotes a hydrogen atom or a hydrocarbon group having 1 to 8 carbon atoms,
d and e independently denote an integer in the range of 0 to 4, and
f denotes an integer in the range of 1 to 10.

3. The thermosensitive recording medium according to claim 1, wherein the compound A is represented by the formula (3): 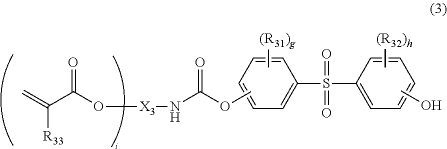
wherein R₃₁ and R₃₂ independently denote a hydrocarbon group having 1 to 8 carbon atoms,
R₃₃ denotes a hydrogen atom or a methyl group,
X₃ denotes a hydrocarbon group having 1 to 49 carbon atoms,
a methylene group in the group denoted by X₃ is optionally substituted with —O—,
g and h independently denote an integer in the range of 0 to 4, and
i denotes an integer in the range of 1 to 10.

4. The thermosensitive recording medium according to claim 1, wherein an amount of the electron-accepting compound with a radical polymerizable group is 1500% or more by mass of an amount of the electron-donating dye precursor.

5. The thermosensitive recording medium according to claim 1, wherein the radical photopolymerization initiator includes an oxime ester compound.

6. The thermosensitive recording medium according to claim 1, wherein the thermosensitive coloring layer contains particles containing the electron-accepting compound with a radical polymerizable group and the radical photopolymerization initiator.

7. An image-forming method comprising the step of heating a thermosensitive recording medium to form an image, wherein
the thermosensitive recording medium includes a thermosensitive coloring layer containing an electron-donating dye precursor, a radical photopolymerization initiator, and an electron-accepting compound with a radical polymerizable group,
the electron-accepting compound with a radical polymerizable group includes a compound A represented by the formula (1): 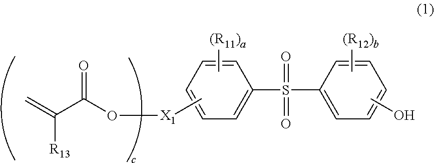
wherein R₁₁ and R₁₂ independently denote a hydrocarbon group having 1 to 8 carbon atoms,
R₁₃ denotes a hydrogen atom or a methyl group,
X₁ denotes a single bond or a hydrocarbon group having 1 to 50 carbon atoms,
a methylene group in the group denoted by X₁ is optionally substituted with a heterocycle, —NHCOO—, —NHCO—, —O—, —CO—, —COO—, or —NR₁₄—,
R₁₄ denotes a hydrogen atom or a hydrocarbon group having 1 to 8 carbon atoms,
a and b independently denote an integer in the range of 0 to 4, and
c denotes an integer in the range of 1 to 10.

8. The image-forming method according to claim 7, wherein the heating is performed by applying a heat pulse to the thermosensitive recording medium using a thermal head.

9. The image-forming method according to claim 7, further comprising the step of irradiating the thermosensitive recording medium on which the image is formed with ultraviolet radiation to fix the thermosensitive coloring layer.
